(19) United States
(12) Patent Application Publication
(10) Pub. No.: US 2003/0004876 A1
(43) Pub. Date: Jan. 2, 2003

(54) Mobile terminal incorporated with a credit card

(76) Inventor: David Jacobson, Elazar (IL)

Correspondence Address: TESTA, HURWITZ & THIBEAULT, LLP, HIGH STREET TOWER, 125 HIGH STREET, BOSTON, MA, 02110, US

(21) Appl. No.: 09/897,780

(22) Filed: Jun. 29, 2001

(51) Int. Cl. G06F 17/60

(52) U.S. Cl. 705/41

(57) ABSTRACT

Payment device including a mobile terminal and a financial data storage element, wherein the mobile terminal and the financial data storage element are logically associated, and wherein the financial data storage element is coupled to the mobile terminal.

### FIELD OF THE INVENTION

The present invention relates to business transactions in general, and to methods and systems for using credit cards, in particular.

### BACKGROUND OF THE INVENTION

Methods and systems for using a credit card to perform a business transaction are known in the art. Such business transactions include the purchase of goods and services, performing a monetary action on a bank account, and the like. A user purchases goods and services either through a salesperson or through a device, such as a vending machine, a computer connected to a network, and the like. Monetary actions on a bank account include withdrawing cash from the bank account, verifying the status of the bank account, transferring funds from one account to another, and requesting other financial services, through an automatic teller machine (ATM).

When the user purchases a product or a service from a salesperson, she pays by presenting her credit card to the salesperson. The credit card includes a magnetic stripe embedded therein. The magnetic stripe stores digital data respective of the owner of the credit card and associated with the bank account or credit card account and the credit card service provider of the owner, information respective of the security of the credit card, and the like. The salesperson copies the digital data to a cash register, by passing the credit card through a card reader. The cash register provides a transaction document on paper, which includes the necessary information for performing the transaction.

If the purchase amount is below a predetermined value, then the user confirms the payment by signing the transaction document. The credit card service provider checks the authenticity of the user (i.e., verifies whether the user is also the owner of the credit card), at a later time. The authentication is performed by comparing the signature on the transaction document, with signature of the user previously recorded according to a contract. If the user is proved to be authentic, then the transaction procedure continues. If the authenticity of the user is not proved, then necessary measures are taken to discontinue the transaction.

If the purchase amount is above the predetermined value, then the salesperson requests a payment authorization from the credit card service provider, by calling the credit card service provider. The credit card service provider authorizes the payment, by providing a transaction authorization code to the salesperson. The salesperson includes the transaction authorization code in the transaction document and the user confirms the payment by signing the transaction document. If the credit card service provider does not authorize the payment, then the salesperson does not accept the payment by the credit card.

When the user purchases a product or a service through a vending machine, she pays by first passing her credit card through the card reader of the vending machine, thereby copying the digital data from the magnetic stripe, to a processor within the vending machine. The processor computes the secret code of the owner of the credit card, by applying an algorithm to a number embedded in the received digital data and requests the user to key in her secret code. If the computed secret code and the keyed-in secret code match, then the processor authenticates the user, accepts the payment and authorizes the purchase. Otherwise, the processor denies the purchase.

When the user performs a monetary action through an ATM, she first passes her credit card through the card reader of the ATM, thereby copying the digital data to an ATM processor within the ATM. The ATM processor authenticates the user and authorizes or denies the requested monetary action, in a manner similar to that described herein above in connection with performing a purchase through a vending machine. If the requested monetary action requires authorization, then the ATM processor establishes connection with a bank processor of the bank, which manages the account of the owner of the credit card and requests an authorization. The ATM processor, then either accepts or denies the requested monetary action, based on the outcome of the authorization request.

Reference is now made to FIG. 1, which is a schematic illustration of a system for performing a transaction, generally referenced 10, as known in the art. System 10 includes a credit card 12, a card reader 14, a service unit 16, a network 18 and a remote authorizing node 20. Credit card 12 includes a magnetic stripe 22. Magnetic stripe 22 stores digital data as described herein above. Service unit 16 includes a keypad 24. Remote authorizing node 20 includes a processor 26 and a look-up table 28.

Service unit 16 is a device for registering a transaction (e.g., a cash register), or a device for registering and providing a service or a product in exchange for payment via credit card 12. Hence, service unit 16 is any of the devices described herein above, such as cash register, vending machine, ATM, and the like. Remote authorizing node 20 is a computer, a mainframe, a bank of computers, and the like, for authenticating a user and authorizing a purchase via a credit card. Network 18 is a conventional information network such as Internet, Intranet, telecommunication network, and the like. Network 18 is either wireless, wired or a combination thereof. Service unit 16 is connected to card reader 14 and to network 18. Remote authorizing node 20 is connected to network 18.

The user passes credit card 12 through card reader 14, whereby card reader 14 reads the digital data stored on magnetic stripe 22 and sends this data to service unit 16. Service unit 16 sends the digital data to remote authorizing node 20, via network 18. Processor, 26 extracts a security number respective of the security of credit card 12, from the digital data and computes a secret code by applying an algorithm to the security number. Alternatively, processor 26 retrieves the secret code from look-up table 28, according to the security number. Remote authorizing node 20 sends the computed or the retrieved secret code to service unit 16, via network 18. Alternatively, service unit 16 includes a processor (not shown) and a look-up table (not shown), wherein service unit 16 either computes the secret code or retrieves the secret code from the look-up table, as described herein above in connection with remote authorizing node 20.

If the purchase amount is below a predetermined amount, then service unit 16 requests the user to key in her secret code via keypad 24. If the computed or the retrieved secret code and the keyed-in secret code match, then service unit 16 authenticates the user of credit card 12, accepts the payment via credit card 12, and provides the product or the service to the user. If the purchase amount is above the predetermined amount, then service unit 16 requests authorization for the purchase of the product or the service, from remote authorizing node 20. Service unit 16 provides the product or the service to the user, upon receipt of authorization from remote authorizing node 20.

U.S. Pat. No. 5,850,599 issued to Seiderman and entitled “Portable Cellular Telephone with Credit Card Debit System”, is directed to a cellular telephone connected to a telecommunications network, which employs a credit card for managing commerce between a user and a vendor. The cellular telephone includes a credit card interface unit connected to a handset and to a transceiver unit, by a bus. The credit card interface includes a credit card reader slot, a plurality of lights and an interface display. The handset includes a handheld unit, which is electrically connected to a cradle. The handheld unit includes a handheld display, a plurality of function keys, a plurality of dial keys and a speaker. The transceiver is connected to the telecommunications network, via an antenna. The credit card interface manages the call and the. transaction of payment between the user and the vendor. The speaker provides voice prompts to the user during the process of placing the call and performing the transaction.

The user selects the vendor and a service respective of the vendor, by interacting with the function keys, the interface display and the speaker. The user initiates a call to the vendor via the dial keys. The credit card interface connects the user to the vendor, after verifying the nature of the call (e.g., a toll-free, 800 and 911) and prompts the user via the speaker and the lights, to swipe the credit card through the credit card reader slot. The user swipes the credit card, the credit card interface checks the validity of the credit card and controls the transaction between the user and the vendor.

U.S. Pat. No. 6,062,887 issued to Schuster et al., and entitled “Electronic Device with Dual Card Reader Employing a Drawer”, is directed to an electronic device capable of accommodating two different types of electronic cards, such as multimedia card (MMC) and subscriber identity module (SIM). The rear housing portion of the electronic device includes a battery pack mating site in the form of a recess, for accommodating a battery pack. The rear housing portion further includes a dual card reader behind the recess.

The dual card reader includes a reader housing and a drawer. The drawer further includes a track assembly for slidably engaging the drawer and the reader housing. The reader housing includes a set of contacts according to a set of pads of the MMC and another set of contacts according to a set of pads of the SIM. For electrically connecting the MMC and the SIM with the electronic device, the user places the MMC and the SIM in the drawer, inserts the drawer in the recess and slides the drawer in the reader housing, wherein the pads of the MMC and the SIM make contact with the respective set of contacts. To disconnect the MMC and the SIM form the electronic device, the user pulls out the drawer from the reader housing to the recess and lifts the drawer from the recess.

U.S. Pat. No. 6,112,077 issued to Spitaletta et al., and entitled “Non-Reusable Cellular Telephone” is directed to a cellular telephone, which can be used for a predetermined time. The cellular telephone includes a microprocessor connected to a keypad, a call rate memory, a remaining time indicator and to a franchise code memory. The microprocessor controls the operation of the cellular telephone. The call rate memory is an erasable programmable read-only memory (EPROM) storage unit, which is programmed with a plurality of rate factors. A rate factor is based on the telephone numbers, which the user normally dials and is determined by the area code, the area code plus the three number dialing prefix, and the like.

The remaining time indicator is a storage unit, such as an erasable-only magnetic strip, and the like. The total time for making telephone calls, is stored in the remaining time indicator, by the manufacturer. When the user commences a call, the erasable-only magnetic strip is sequentially erased at a rate specified by the microprocessor, selected from the call rate memory and run by a clock. The franchise code memory is a storage unit for storing the information necessary for making calls in the calling areas which are served by the cellular service provides, according to a contract. The user can not access calling areas for which no information is stored in the franchise code memory.

When the user turns on the cellular telephone, the microprocessor checks the remaining calling time stored in the remaining time indicator. If the remaining calling time is zero, then the microprocessor disables the cellular telephone and the user can dispose of the cellular telephone. If the remaining calling time is greater than zero, then the microprocessor enables the cellular telephone. When the cellular telephone is connected to a called party, the remaining time indicator starts and the remaining calling time depreciates at a rate specified by the call rate memory. The remaining time indicator reports the remaining calling time to the user, via a light source, a vibrator or a tone generator which is mounted on the housing of the cellular telephone. The light source flashes at a rate inversely proportional to the remaining calling time. When the remaining calling time is zero, the microprocessor disables the cellular telephone by disabling the transmitter and the receiver of the cellular telephone. The call is disconnected and the user can dispose of the cellular telephone.

U.S. Pat. No. 5,748,737 issued to Dagger, and entitled “Multimedia Electronic Wallet with Generic Card”, is directed to a device and a method for using a plurality of digital cards. The device includes an electronic wallet and a generic multi-media card. The electronic wallet includes a wallet micro-module connected to a display, a magnetic reader/writer, a smart card reader/writer, a radio frequency transceiver, a battery, a clock/calendar and a keypad.

The electronic wallet further includes a card slot. The wallet micro-module provides processing means and storage means. The magnetic reader/writer allows the electronic wallet to read or write data on a magnetic stripe of a digital card. The smart card reader/writer allows the electronic wallet to read or write data on a smart card. The radio frequency transceiver provides short-range radio communication between the electronic wallet and another electronic wallet, or a radio communication device. The generic multi-media card includes a magnetic stripe and a card micro-module.

The user interacts with the electronic wallet via the display and the keypad. The user sequentially inserts a plurality of digital cards in the slot of the electronic wallet and uploads the digital data from the digital cards, to the wallet micro-module. The user then directs the electronic wallet to write the uploaded digital data on the magnetic stripe and the card micro-module of the generic multi-media card, via the magnetic reader/writer and smart card reader/writer, respectively. The user can use the generic multi-media card instead of each of the digital cards, by interfacing the generic multi-media card with another magnetic reader/writer or smart card reader/writer.

### SUMMARY OF THE PRESENT INVENTION

It is an object of the present invention to provide a novel method and system for paying for the purchase of goods and services, by a credit card.

In accordance with the present invention, there is thus provided a payment device. The payment device includes a mobile terminal and a financial data storage element connected to the mobile terminal, wherein the mobile terminal is logically associated with the financial data storage element.

In accordance with another aspect of the present invention, there is thus provided a card holder for connecting the financial data storage element to the mobile terminal. The card holder is connected to the mobile terminal and the financial data storage element is logically associated with the mobile terminal.

In accordance with a further aspect of the present invention, there is thus provided a flipping cover detachably attached to a flip-phone. The flipping cover includes credit card information, which is logically associated with the flip-phone.

In accordance with another aspect of the present invention, there is thus provided a method for authenticating a user who performs a transaction, by employing the financial data storage element, which is connected to the mobile terminal. The method includes the steps of initiating communication with the mobile terminal according to the mobile terminal ID, requesting a user secret code, receiving the user secret code from the mobile terminal at a remote authorizing node and determining the authenticity of the user.

In accordance with a further aspect of the present invention, there is thus provided a method for authenticating the user, by employing the financial data storage element, which is connected to the mobile terminal. The method includes the steps of determining a first authentication code according to the credit card information stored in a credit card storage medium and receiving the user secret code by the mobile terminal, from the user. The method further includes the steps of determining a second authentication code according to the user secret code and comparing the first authentication code with the second authentication code.

### BRIEF DESCRIPTION OF THE DRAWINGS

The present invention will be understood and appreciated more fully from the following detailed description taken in conjunction with the drawings in which:

FIG. 1 is a schematic illustration of a system for performing a transaction as known in the art;

FIG. 2 is a schematic illustration of a mobile terminal, constructed and operative in accordance with a preferred embodiment of the present invention;

FIG. 3 is a schematic illustration of a mobile terminal, constructed and operative in accordance with another preferred embodiment of the present invention;

FIG. 4 is a schematic illustration of a method to use the mobile terminal of FIG. 2, operative in accordance with a further preferred embodiment of the present invention;

FIG. 5 is a schematic illustration of a method to use the mobile terminal of FIG. 3, operative in accordance with another preferred embodiment of the present invention;

FIG. 6A is a schematic illustration of a mobile terminal, constructed and operative in accordance with a further preferred embodiment of the present invention;

FIG. 6B is a schematic illustration of view A (right side view) of the mobile terminal of FIG. 6A;

FIG. 6C is a schematic illustration of the mobile terminal of FIG. 6A, wherein a credit card is drawn out of the mobile terminal;

FIG. 7A is a schematic illustration of a mobile terminal, constructed and operative in accordance with another preferred embodiment of the present invention;

FIG. 7B is a schematic illustration of view B (left side view) of the mobile terminal of FIG. 6A;

FIG. 8A is a schematic illustration of a mobile terminal, constructed and operative in accordance with a further preferred embodiment of the present invention;

FIG. 8B is a schematic illustration of view C (bottom view) of the mobile terminal of FIG. 8A;

FIG. 8C is a schematic illustration of the mobile terminal of FIG. 8A, wherein a credit card is drawn out of the mobile terminal;

FIG. 9A is a schematic illustration of a mobile terminal, constructed and operative in accordance with another preferred embodiment of the present invention;

FIG. 9B is a schematic illustration of view D (top view) of the mobile terminal of FIG. 9A;

FIG. 9C is a schematic illustration of the mobile terminal of FIG. 9A, wherein a credit card is drawn out of the mobile terminal;

FIG. 10A is a schematic illustration of a mobile terminal, constructed and operative in accordance with a further preferred embodiment of the present invention;

FIG. 10B is a schematic illustration of the mobile terminal of FIG. 10A, with the credit card in an extended position;

FIG. 11A is a schematic illustration of a mobile terminal, constructed and operative in accordance with another preferred embodiment of the present invention;

FIG. 11B is a schematic illustration of the mobile terminal of FIG. 11A, with the credit card in an extended position;

FIG. 12A is a schematic illustration of a mobile terminal, constructed and operative in accordance with a further preferred embodiment of the present invention;

FIG. 12B is a schematic illustration of the mobile terminal of FIG. 12A, with the credit card in an extended position;

FIG. 13A is a schematic illustration of a mobile terminal, constructed and operative in accordance with another preferred embodiment of the present invention;

FIG. 13B is a schematic illustration of the mobile terminal of FIG. 13A, with the credit card in an extended position;

FIG. 14A is a schematic illustration of the top view of a mobile terminal, constructed and operative in accordance with a further preferred embodiment of the present invention;

FIG. 14B is a schematic illustration of the mobile terminal of FIG. 14A, with the credit card in an extended position;

FIG. 15A is a schematic illustration of the top view of a mobile terminal, constructed and operative in accordance with another preferred embodiment of the present invention;

FIG. 15B is a schematic illustration of the mobile terminal of FIG. 15A, with the credit card in an extended position;

FIG. 16A is a schematic illustration of a mobile terminal, constructed and operative in accordance with a further preferred embodiment of the present invention;

FIG. 16B is a schematic illustration of the mobile terminal of FIG. 16A, with the credit card in an extended position;

FIG. 17A is a schematic illustration of the side view of a mobile terminal, constructed and operative in accordance with another preferred embodiment of the present invention;

FIG. 17B is a schematic illustration of the mobile terminal of FIG. 17A, with the credit card in an extended position;

FIG. 17C is a schematic illustration of view E (front view) of the mobile terminal of FIG. 17B;

FIG. 18A is a schematic illustration of the side view of a mobile terminal, constructed and operative in accordance with a further preferred embodiment of the present invention;

FIG. 18B is a schematic illustration of view F (front view) of the mobile terminal of FIG. 18A;

FIG. 18C is a schematic illustration of the mobile terminal of FIG. 18B, with the credit card in an extended position;

FIG. 19A is a schematic illustration of the side view of a mobile terminal, constructed and operative in accordance with another preferred embodiment of the present invention;

FIG. 19B is a schematic illustration of the mobile terminal of FIG. 19A, with the credit card in an extended position;

FIG. 19C is a schematic illustration of view G (top view) of the mobile terminal of FIG. 19B;

FIG. 20A is a schematic illustration of a mobile terminal, constructed and operative in accordance with a further preferred embodiment of the present invention;

FIG. 20B is a schematic illustration of view H (bottom view) of the mobile terminal of FIG. 20A;

FIG. 20C is a schematic illustration of the mobile terminal of FIG. 20A, with a credit card in an extended position;

FIG. 21A is a schematic illustration of the rear view of a mobile terminal, constructed and operative in accordance with another preferred embodiment of the present invention;

FIG. 21B is a schematic illustration of the mobile terminal of FIG. 21A, with the credit card in an extended position;

FIG. 21C is a schematic illustration of section J-J (latch mechanism) of the mobile terminal of FIG. 21A;

FIG. 22A is a schematic illustration of the top view of a mobile terminal, constructed and operative in accordance with a further preferred embodiment of the present invention;

FIG. 22B is a schematic illustration of view K (rear view) of the mobile terminal of FIG. 22A;

FIG. 22C is a schematic illustration of the mobile terminal of FIG. 22A, with the credit card in an extended position;

FIG. 22D is a schematic illustration of view L (rear view) of the mobile terminal of FIG. 22C;

FIG. 23A is a schematic illustration of the rear view of a mobile terminal, constructed and operative in accordance with another preferred embodiment of the present invention;

FIG. 23B is a schematic illustration of the mobile terminal of FIG. 23A, with the credit card in an extended position;

FIG. 23C is a schematic illustration of view M (top view) of the mobile terminal of FIG. 23B;

FIG. 24A is a schematic illustration of the rear view of a mobile terminal, constructed and operative in accordance with a further preferred embodiment of the present invention;

FIG. 24B is a schematic illustration of the mobile terminal of FIG. 24A, with the credit card in an extended position;

FIG. 24C is a schematic illustration of section N-N of the mobile terminal of FIG. 24A;

FIG. 24D is a schematic illustration of section P-P of the mobile terminal of FIG. 24B;

FIG. 25A is a schematic illustration of the rear view of a mobile terminal, constructed and operative in accordance with another preferred embodiment of the present invention;

FIG. 25B is a schematic illustration of view Q (top view) of the mobile terminal of FIG. 25A;

FIG. 25C is a schematic illustration of the mobile terminal of FIG. 25B, with the four-bar linkage in an intermediate position;

FIG. 25D is a schematic illustration of the mobile terminal of FIG. 25A, with the credit card in an extended position;

FIG. 25E is a schematic illustration of view R (top view) of the mobile terminal of FIG. 25D;

FIG. 26A is a schematic illustration of the rear view of a mobile terminal, constructed and operative in accordance with a further preferred embodiment of the present invention;

FIG. 26B is a schematic illustration of the mobile terminal of FIG. 26A, with the credit card detached from the mobile terminal;

FIG. 27A is a schematic illustration of the rear view of a mobile terminal, constructed and operative in accordance with another preferred embodiment of the present invention;

FIG. 27B is a schematic illustration of the mobile terminal of FIG. 27A, with the credit card removed from the pocket;

FIG. 28A is a schematic illustration of the rear view of a mobile terminal, constructed and operative in accordance with a further preferred embodiment of the present invention;

FIG. 28B is a schematic illustration of the mobile terminal of FIG. 28A, with the credit card in an extended position;

FIG. 28C is a schematic illustration of section S-S of the credit card hinge assembly of FIG. 28B;

FIG. 28D is a schematic illustration of the mobile terminal of FIG. 28B, without the credit card;

FIG. 28E is a schematic illustration of the credit card of FIG. 28B; and

FIG. 28F is a schematic illustration of section T-T of the credit card hinge assembly of FIG. 28D.

### DETAILED DESCRIPTION OF PREFERRED EMBODIMENTS

The present invention overcomes the disadvantages of the prior art by providing a cellular telephone and a credit card connected together and both belonging to a user. The user is authenticated by comparing the information embedded in the credit card with the information stored in the cellular telephone. Furthermore, a transaction authorization code can be reported to the vendor, via the cellular telephone.

The term “mobile terminal” herein below, refers to a cellular telephone which is associated with a macrocellular communication system, a microcellular communication system, a personal communication service (PCS), and the like. A macrocellular communication system employs a plurality of base stations, where each base station transmits and receives signals from mobile terminals, located within a substantially large radius from the base station (e.g., 5 km). In a microcellular communication system, the base station transmits and receives signals from mobile stations located within a substantially small radius from the base station (e.g., a few tens of meters). A personal communication system (PCS) provides high mobility long-range cellular communication services, whereby the system provides communication services to the user, regardless of the point of attachment of the terminal to the network. Furthermore, the user connected to a PCS can connect to the network, via any mobile terminal, by providing a global user identification number.

The term “front side” herein below, refers to that main side of a mobile terminal which the user employs for communication. The term “rear side” herein below, refers to that side of the mobile terminal located opposite to the front side. The terms “right side” and “left side” herein below, refer to the right side and the left side of the mobile terminal, respectively, as the front side of the mobile terminal is viewed. The terms “top side” and “bottom side” herein below refer to the top side and the bottom side of the mobile terminal, respectively, as the front side of the mobile terminal is viewed.

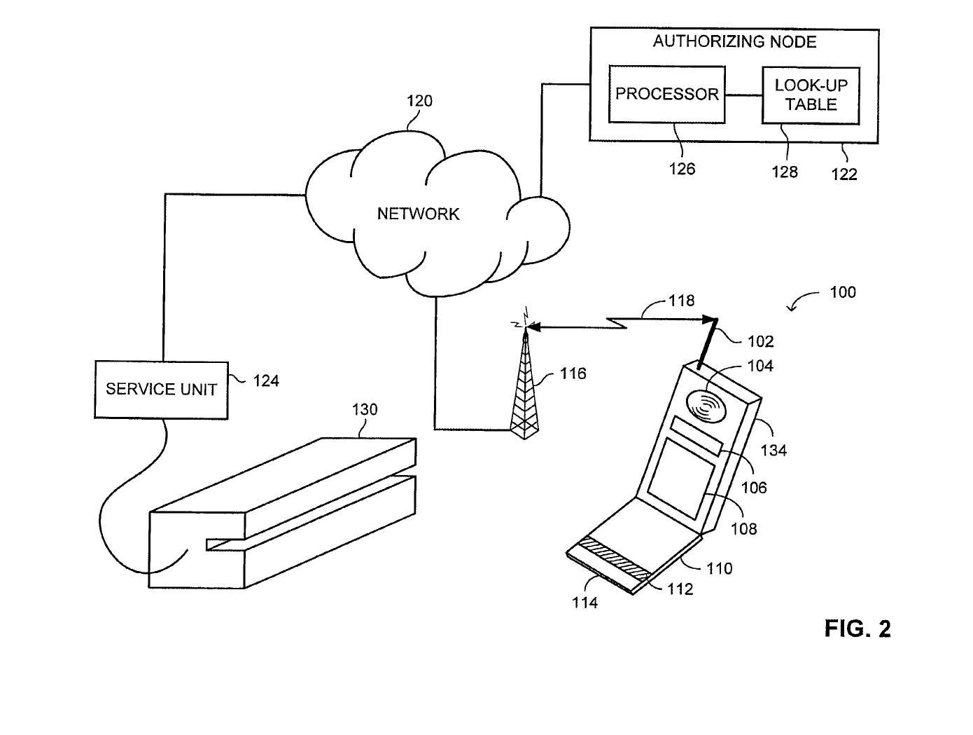

Reference is now made to FIG. 2, which is a schematic illustration of a mobile terminal, generally referenced 100, constructed and operative in accordance with a preferred embodiment of the present invention. Mobile terminal 100 includes a handset 134 and a flipping cover 110. Handset 134 includes an antenna 102, a speaker 104, a display 106, a keypad 108 and a video camera (not shown). Flipping cover 110 includes a financial data storage element, such as magnetic stripe 112. Magnetic stripe 112 stores credit card information. This credit card information includes the credit card number, the user secret code, user information, credit card type, and the like.

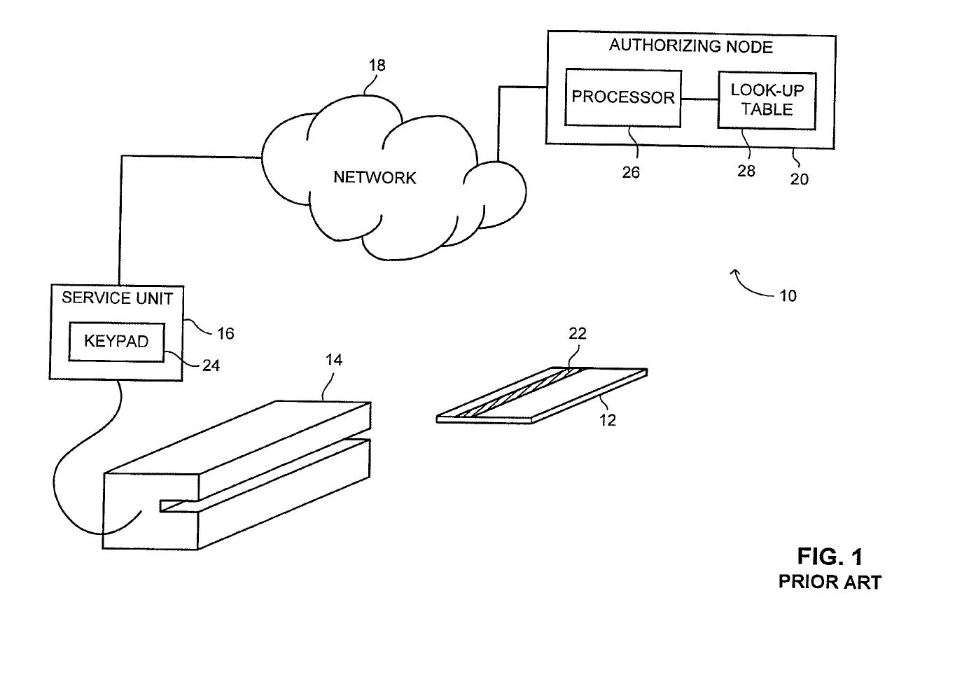

Flipping cover 110 is an extendable part of mobile terminal 100. Flipping cover 110 is connected to handset 134 by a hinge (not shown). Flipping cover 110 can rotate about the hinge and thus, can be either in a closed or an open position relative to handset 134. In the example set forth in FIG. 1, flipping cover 110 is shown in an open position. Display 106 provides a textual image, a graphical image, a video image, and the like.

The credit card information stored on magnetic stripe 112 and the mobile ID of mobile terminal 100 are associated with the same user. For example, a credit card service provider assigns both the credit card information of magnetic stripe 112 and the mobile ID of mobile terminal 100, to the user. Thus, the user is the owner of mobile terminal 100, while the credit card information associated with the user is stored on magnetic stripe 112.

The mobile ID includes a mobile identification number (MIN), a universal personal telecommunications number (UPT), a terminal identifier (TID), a personal identification number (PIN), and the like. The mobile ID includes information respective of mobile terminal 100, as well as information respective of the user who uses cellular telecommunication services. For example, a MIN or a TID is assigned to mobile terminal 100, while a UPT or a PIN is assigned to the user. Hence, the user, having a single UPT can own a number of different mobile terminals and pay for the purchase of products or services, using different mobile terminals on different occasions.

Magnetic stripe 112 is located in a transverse position relative to flipping cover 110 and substantially close to an outer edge 114 of flipping cover 110. The thickness of flipping cover 110 at least in the vicinity of magnetic stripe 112 is substantially equal to the thickness of conventional credit cards. Hence, edge 114 of flipping cover 110 can be passed through a conventional card reader, whereby the card reader reads the credit card information embedded in magnetic stripe 112.

Mobile terminal 100 is connected to a base station 116 via a radio channel 118 and antenna 102. Base station 116 is connected to a network 120. Network 120 is a conventional communication network such as Internet, Intranet, a telecommunication network, and the like. Network 120 is either wireless, wired or a combination thereof. A remote authorizing node 122 and a service unit 124 are further connected to network 120. Remote authorizing node 122 is a computer, a main-frame, a bank of computers, and the like, which stores and processes information respective of personal characteristics of credit card owners, information respective of these credit cards, information respective of the mobile terminal of these credit card owners, and the like.

Service unit 124 is a cash register, a vending machine, an automatic teller machine (ATM), and the like. Service unit 124 includes a service unit memory (not shown), such as random access memory (RAM), for temporary storage of the credit card information of magnetic stripe 112. Service unit 124 is capable of performing processing operations. Service unit 124 has access to a list of unauthorized credit card numbers. The owner of a credit card whose number is included in the list of unauthorized credit card numbers, is unauthorized to use the credit card, according to a policy of the credit card service provider.

Remote authorizing node 122 includes a processor 126 and a look-up table 128. Look-up table 128 is updated at predetermined time intervals (e.g., once a day, once a week, once a month, and the like). Look-up table 128 includes a record for each credit card number. Each record includes a plurality of fields respective of the credit card number, such as the user secret code, the mobile ID of the mobile terminal owned by the user, unique audio data, unique alphanumeric data, unique visual data, account status, and the like. The mobile ID includes the TID, MIN, PIN, UPT, and the like. The unique audio data includes the voice characteristics of the owner of the credit card, such as a frequency spectrum, sound pressure, and the like. The unique alphanumeric data includes at least one alphanumeric character embedded in a selected word or a selected number. For example, the alphanumeric characters can be the letters “mi”, which are the second and third letters in the word “Smith”. The unique visual data includes an image respective of the owner of the credit card owner, such as a color or a gray scale bit map of the face of the credit card owner, and the like.

The account status field includes information respective of approval or disapproval of the transaction, according to a contract between the user and the credit card service provider. The account status field includes a non-authenticated-limit-value, an authenticated-limit-value, a transaction code, and the like. For example, if the transaction value is greater than the limited value, or if the requested transaction code does not match the stored transaction code, then the approval is not granted.

Look-up table 128 furthermore includes a list of unauthorized credit card numbers. The owner of a credit card whose number is included in the list of unauthorized credit card numbers, is not authorized to use the credit card, according to a policy of the credit card service provider.

A card reader 130 is connected to service unit 124. Alternatively, card reader 130 is integrated with service unit 124. The connection of either of remote authorizing node 122 and service unit 124 to network 120 is either wireless, wired, or a combination thereof.

Following is a description of a process wherein the user attempts to pay a salesperson for the purchase of a product or a service, using mobile terminal 100. In this case service unit 124 is a cash register. The user passes edge 114 of flipping cover 110 through card reader 130, wherein card reader 130 reads the credit card information stored on magnetic stripe 112. Card reader 130 stores the credit card information in the service unit memory of service unit 124. Service unit 124 produces a transaction document respective of at least a portion of the credit card information and the information respective of the product or the service, which is to be purchased.

The required level of authorization (i.e., no authorization, limited local authentication, network authentication, and the like) can be determined according to the transaction value, with respect to the type of credit card (e.g., regular, gold, platinum and the like). For example, if the transaction value is below a first value (e.g., below $20), then service unit 124 compares the received credit card number with the list of unauthorized credit card numbers stored in service unit 124. If the received credit card number matches with a number in the list of unauthorized credit card numbers, then service unit 124 denies the transaction and reports the denial to the salesperson. If the received credit card number is not found in the list of unauthorized credit card numbers, then service unit 124 authorizes the transaction. Finally, the user completes the purchase, merely by signing the transaction document.

If the transaction value is between the first value and a second value (e.g., between $20-100), then the system performs a network authorization process. Accordingly, the system either accepts or denies the purchase, according to the outcome of the network authorization process. In this network authorization process, service unit 124 extracts the credit card number from the credit card information and sends the credit card number and the transaction value to remote authorizing node 122, via network 120.

Processor 126 compares the received credit card number with the credit card numbers in a list of unauthorized credit card numbers. If the received credit card number matches a number in the list of unauthorized credit card numbers, then remote authorizing node 122 sends a message to service unit 124 via network 120, to deny the purchase.

If the received credit card number is not found in the list of unauthorized credit card numbers, then processor 126 compares the transaction value with the non-authenticated-limit-value associated with the credit card record. If the transaction value is less than the non-authenticated-limit-value, then processor 126 produces a transaction authorization code and remote authorizing node 122 authorizes the transaction by sending the transaction authorization code to service unit 124, via network 120. Service unit 124 enters the received transaction authorization code in the transaction document. The user completes the transaction by signing the transaction document.

Alternatively, remote authorizing node 122 authorizes the transaction by sending the transaction authorization code to mobile terminal 100. The user reports the received transaction authorization code to the salesperson, the salesperson enters the received transaction authorization code to service unit 124 and service unit 124 enters the received transaction authorization code in the transaction document. The user completes the transaction by signing the transaction document.

If the transaction value is greater than the non-authenticated-limit-value and less than the authenticated-limit-value associated with the credit card record (e.g., greater than $100 and less than $1000), then service unit 124 requests from remote authorizing node 122, authorization for performing the transaction, after authenticating the user.

In this case, the system performs a network authentication authorization process, as follows. Processor 126 retrieves the user secret code and the mobile ID of mobile terminal 100, from the record, which corresponds with the received credit card number. Remote authorizing node 122 initiates communication with mobile terminal 100 according to the mobile ID of mobile terminal 100. When the user answers the call, remote authorizing node 122 requests the secret code from the user via the mobile terminal user interface (i.e., by displaying text or graphics on display 106, by sounding a request message on speaker 104, and the like). For example, the following message appears on display 106: “Please enter your secret code”.

At this stage, the user is required to provide the secret code thereto, via the mobile terminal user interface (i.e., either by punching in the code in the keypad, speaking the secret code to the microphone of the mobile terminal 100, and the like).

According to the present example, the user enters her secret code via keypad 108 or by uttering the secret code in the microphone and sends the entered secret code to remote authorizing node 122, via network 120. Processor 126 compares the received secret code with the retrieved secret code. If the received secret code and the retrieved secret code match, then processor 126 determines that the user is authentic and processor 126 determines a transaction authorization code for the purchase of the goods.

Remote authorizing node 122 sends the transaction authorization code to service unit 124, via network 120 and service unit 124 enters the received transaction authorization code in the transaction document. The user may further be required to complete the transaction by signing the transaction document.

Alternatively, remote authorizing node 122 sends the transaction authorization code to mobile terminal 100. The user reports the received transaction authorization code to the salesperson, the salesperson enters the received transaction authorization code to service unit 124 and service unit 124 enters the received transaction code in the transaction document. Again, the user may further be required to complete the transaction by signing the transaction document.

Alternatively, remote authorizing node 122 sends a message to service unit 124 via network 120, to accept the purchase, merely by receiving confirmation that the user has answered the call. The user, then completes the transaction, by signing the transaction document.

If the received secret code and the retrieved secret code do not match, then processor 126 determines that the user is not authentic and remote authorizing node 122 sends a message to service unit 124 via network 120, to deny the purchase. If the user does not answer the call, then remote authorizing node 122 determines that the user is not authenticated and sends a message to service unit 124 to deny the purchase, or to request the user to switch on her mobile terminal 100 and to notify service unit 124 to retry the above procedure.

Alternatively, processor 126 retrieves the voice characteristics from the unique audio data field of the credit card number and remote authorizing node 122 prompts the user to utter a predetermined phrase. The user utters the predetermined phrase in the microphone and sends the data respective of the predetermined phrase, to remote authorizing node 122. Processor 126 processes the received predetermined phrase and produces a received voice characteristic therefrom. Processor 126 compares the retrieved voice characteristics with the received voice characteristics. If the retrieved voice characteristics and the received voice characteristics match, then remote authorizing node 122 authorizes the transaction. Otherwise, remote authorizing node 122 denies the transaction.

Alternatively, remote authorizing node 122 employs the unique alphanumeric data to authorize the transaction. For this purpose, processor 126 retrieves the alphanumeric characters from unique alphanumeric data field of the record of the credit card number. Remote authorizing node 122 requests the user, via the mobile terminal user interface, to enter the alphanumeric characters via the mobile terminal user interface and send these alphanumeric characters to remote authorizing node 122. Processor 126, then compares the retrieved alphanumeric characters with the received alphanumeric characters. If the retrieved alphanumeric characters and the received alphanumeric characters match, then remote authorizing node 126 authorizes the transaction, otherwise the remote authorizing node does not authorize the transaction. For example, if the name of the father of the user is “Smith”, then remote authorizing node 122 requests the user to key in the second and the third letter in the name of her father. The user, then keys in the letter “mi” via keypad 108.

Alternatively, processor 126 retrieves the image from the unique visual data field of the record of the credit card number and prompts the user, for example, to look at the front side of mobile terminal 100. The video camera detects the image of the face of the user and sends the detected image, to remote authorizing node 122. Processor 126 processes the received image and compares the processed image with the retrieved image. If the processed image and the retrieved image match, then remote authorizing node 122 authorizes the transaction. Otherwise, remote authorizing node 122 denies the transaction.

If the transaction value is greater than the authenticated-limit-value (e.g., greater than $1000), then remote authorizing node 122 denies the purchase and sends a denial message to service unit 124, via network 120, indicating the need for human intervention, in order to authorize the purchase. It is noted that each of the above authorization procedures (i.e., local authentication, network authentication authorization, and the like) is applicable for any transaction value. For example, a system can be designed so that every transaction requires network authentication authorization.

Following is a description of a process by which the user of mobile terminal 100 attempts to perform a transaction, directly through service unit 124, without the mediation of a salesperson. In this case, service unit 124 is a vending machine, an automatic teller machine (ATM), and the like.

In case service unit 124 is a vending machine, the transaction is the purchase of a product. The user selects the product and passes edge 114 through card reader 130, whereby service unit 124 receives the credit card number, the user secret code and the user information from magnetic stripe 112. If the price of the product is below a predetermined value, then service unit 124 accepts the transaction after authenticating the user. If the price of the product is above the predetermined value, then the vending machine establishes communication with remote authorizing node 122 via network 120, sends the received credit card number and the transaction value to remote authorizing node 122 and requests a transaction authorization therefrom. Service unit 124 accepts the transaction after receiving the transaction authorization from remote authorizing node 122.

In case service unit 124 is an ATM, the transaction is withdrawing of cash from the bank account of the owner of mobile terminal 100, verifying the status of the bank account, transfer of funds between the bank account and another bank account, requesting other monetary services, and the like. The user commences the transaction, by passing edge 114 through card reader 130, whereby service unit 124 receives the credit card number, the user secret code and the user information from magnetic stripe 112. The user, then selects a service having a transaction code, via a service unit user interface (not shown), integrated with service unit 124. Service unit 124 determines whether the transaction can be performed without obtaining a transaction authorization, according to the transaction code. If the transaction can be performed without obtaining authorization from remote authorizing node 122, then service unit 124 accepts the transaction after authenticating the user. If the transaction requires authorization of remote authorizing node 122, then service unit 124 accepts the transaction after receiving authorization from remote authorizing node 122.

Service unit 124 compares the received credit card number with a local list of unauthorized credit card numbers stored therein. If the received credit card number matches with a number in the local list of unauthorized credit card numbers, then service unit 124 denies the transaction and reports the denial to the user via the service unit user interface. If the received credit card number is not found in the local list of unauthorized credit card numbers, then service unit 124 continues to perform the transaction.

If the transaction can be performed by merely authenticating the user, and without the need to obtaining a transaction authorization, then service unit 124 prompts the user to enter her user secret code via the service unit user interface. Service unit 124 compares the received user secret code with the entered user secret code. If the received user secret code and the entered user secret code match, then service unit 124 accepts the transaction. Otherwise, service unit 124 denies the transaction and reports the denial via the service unit user interface.

If the transaction requires authorization from remote authorizing node 122, then service unit 124 establishes communication with remote authorizing node 122 and sends the received credit card number to remote authorizing node 122. Processor 126 compares the received credit card number with the credit card numbers in a global list of unauthorized credit card numbers. If the received credit card number matches a number in global the list of unauthorized credit card numbers, then remote authorizing node 122 sends a message to service unit 124 via network 120, to deny the purchase.

If the received credit card number is not found in the global list of unauthorized credit card numbers, then processor 126 continues the network authentication authorization process. Processor 126 compares the received transaction value or the received transaction code, with the stored limited value or the stored transaction code, respectively, in the account status field of the record of the received credit card number. Processor 126 determines whether the user is authorized to perform the transaction, according to the outcome of the comparison and remote authorizing node 122 sends a message to service unit 124 respective of the comparison outcome. Remote authorizing node 122 can send this message also to mobile terminal 100. Service unit 124 either accepts or denies the transaction, according to the received comparison outcome.

Alternatively, processor 126 retrieves the mobile ID of mobile terminal 100 from look-up table 122, according to the received credit card number and initiates communication with mobile terminal 100, according to the retrieved mobile ID. If the user answers the call, then remote authorizing node 122 authorizes the transaction and sends an authorization message to service unit 124 via network 120. Remote authorizing node 122 can send the comparison outcome also to mobile terminal 100. Otherwise, remote authorizing node 122 sends a denial message to service unit 124.

Alternatively, processor 126 retrieves the user secret code from the record of the credit card number and produces a retrieved authentication secret code from the retrieved user secret code, by applying an authorizing time function to the retrieved user secret code. Remote authorizing node 122 prompts the user to enter her user secret code via the mobile terminal user interface (e.g., display 106 or keypad 108). The mobile terminal processor produces an authentication secret code from the entered user secret code, by applying a mobile terminal time function (which is identical with the authorizing time function) to the entered user secret code. The user, then sends the authentication secret code to remote authorizing node 122, via mobile terminal 100 and processor 126 compares the retrieved authentication secret code with the received authentication secret code. Processor 126 determines whether the user is authorized to perform the transaction, according to the outcome of the comparison and remote authorizing node 122 sends a message to service unit 124 respective of the comparison outcome. Remote authorizing node 122 can send this message also to mobile terminal 100. Service unit 124 either accepts or denies the transaction, according to the received comparison outcome.

Alternatively, processor 126 compares the retrieved voice characteristics with the received voice characteristics, the retrieved alphanumeric characters with the received alphanumeric characters, or the processed image with the retrieved image, as described herein above. Processor 126 determines whether the user is authorized to perform the transaction, according to the outcome of the comparison and remote authorizing node 122 sends a message to service unit 124 respective of the comparison outcome. Remote authorizing node 122 can send this message also to mobile terminal 100. Service unit 124 either accepts or denies the transaction, according to the received comparison outcome.

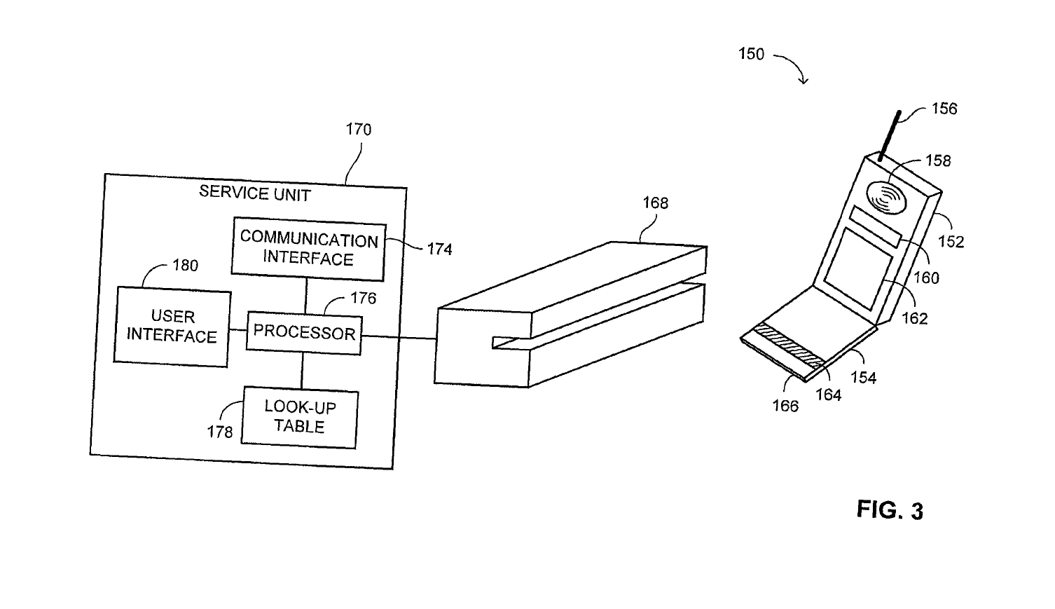

Reference is now made to FIG. 3, which is a schematic illustration of a mobile terminal, generally referenced 150, constructed and operative in accordance with another preferred embodiment of the present invention. Mobile terminal 150 includes a handset 152 and a flipping cover 154. Handset 152 includes an antenna 156, a speaker 158, a display 160, a keypad 162 and a microphone. Flipping cover 154 includes a magnetic stripe 164 at an edge 166 of flipping cover 154. Mobile terminal 150 functions together with a card reader 168 and a service unit 170. Service unit 170 includes a communication interface 174, a processor 176, a look-up table 178 and a service unit user interface 180.

Display 160, flipping cover 154, magnetic stripe 164 and service unit 170 are similar to display 106, flipping cover 110, magnetic stripe 112 and service unit 124 respectively, as described herein above in connection with FIG. 2. Communication interface 174 provides communication between service unit 170 and another electronic device, according to a short range radio communication protocol, such as Bluetooth, and the like. Service unit user interface 180 is a display (e.g., textual, graphical, video), a keypad, a speaker, a headphone, a microphone, and the like. Look-up table 178 is updated at predetermined time intervals (e.g., once a day, once a week, once a month, and the like). Look-up table 178 includes an approved credit card number list and a local list of unauthorized credit card numbers. Each credit card number in the approved credit card number list, points to a user secret code. The local list of unauthorized credit card numbers of look-up table 178 is similar to the global list of unauthorized credit card numbers of look-up table 128 (FIG. 2), except that look-up table 128 is updated frequently (e.g., daily), whereas look-up table 178 is not (e.g., once a week). Processor 176 includes a processor memory (not shown), such as random access memory (RAM), for temporary storage of the credit card information of magnetic stripe 164.

Card reader 168 is connected to service unit 170. Alternatively, card reader 168 is integrated with service unit 170. Processor 176 is connected to communication interface 174, look-up table 178 and to service unit interface 180.

Following is a description of a process wherein the user attempts to pay a salesperson for purchase of a product or a service, using mobile terminal 150. The user copies the credit card information stored on magnetic stripe 164, to the processor memory of processor 176, as described herein above in connection with FIG. 2. Service unit 170 produces a transaction document for the product or the service, which the user intends to purchase, as described herein above in connection with FIG. 2. Service unit 170 compares the received credit card number with the local list of unauthorized credit card numbers stored in look-up table 178. If the received credit card number matches with a number in the local list of unauthorized credit card numbers, then service unit 170 denies the transaction and reports the denial to the salesperson. If the received credit card number is not found in the local list of unauthorized credit card numbers, then the salesperson continues to perform the transaction.

If the transaction value is below a predetermined value, then the salesperson accepts the sale of the product or the service without authenticating the user, and the user completes the purchase by signing the transaction document.

If the transaction value is above the predetermined value, then the salesperson commences an authentication process. Processor 176 retrieves the user secret code, from look-up table 178 according to the credit card number stored in the processor memory of processor 176. Processor 176 modifies the retrieved user secret code, by applying a service unit time function thereto, thereby producing a first authentication code. The service unit time function is a time dependent function, which yields a different value at selected time intervals, such as every five minutes. For example, on 10:12 A.M. processor 176 retrieves a user secret code 202 from the record of the received credit card number. At this time, the service unit time function yields a value of 2. Processor 176 then multiplies the retrieved user secret code of 202 by the output 2 of the service unit time function and computes a first authentication code 404.

Simultaneously, the user enters her user secret code in mobile terminal 150, in response to a request by service unit 170, which appears in service unit user interface 180. A mobile terminal processor included within mobile terminal 150, applies a mobile terminal time function, identical with the service unit time function, to the entered user secret code, thereby producing a second authentication code. Mobile terminal 150 reports the second authentication code to the user, via the mobile terminal user interface (i.e., speaker 158 or display 160). The user reports the second authentication code to the salesperson and the salesperson enters the second authentication code to processor 176, via service unit user interface 180.

Processor 176 compares the first authentication code with the second authentication code. If the first authentication code and the second authentication code match, then processor 176 determines that the user is authentic (i.e., the user is also the owner of mobile terminal 150). Processor 176 directs the salesperson to accept the transaction and the user completes the transaction by signing the transaction document. If the first authentication code is not identical with the second authentication code, then processor 176 determines that the user is not authentic and directs the salesperson to deny the transaction.

Alternatively, service unit 170 initiates a request to the user to enter her user secret code, by communicating with mobile terminal 150, according to a short range radio communication protocol, such as Bluetooth, and the like. Mobile terminal 150, in turn produces the second authentication code and transmits the second authentication code to service unit 170, according to the same short range radio communication protocol.

Processor 176 retrieves the user secret code from look-up table 178, according to the credit card number stored in the processor memory of processor 176. Processor 176 produces a first authentication code from the retrieved user secret code, by applying the service unit time function to the retrieved user secret code. Processor 176 transmits a request to the user via communication interface 174 and antenna 156, to enter her user secret code. The user enters the user secret code to mobile terminal 150, via the mobile terminal user interface. The mobile terminal processor produces a second authentication code from the entered user secret code, as described herein above and transmits the second authentication code via antenna 156 and communication interface 174, to processor 176. Processor 176 stores this transmitted second authentication code in the processor memory therein.

Processor 176 determines the authenticity of the user, by comparing the first authentication code with the second authentication code. Processor 176 directs the salesperson to either accept or deny the transaction, according to the outcome of the comparison.

Following is a description of a process by which the user of mobile terminal 150 attempts to perform a transaction, directly through service unit 170, without the mediation of a salesperson. In this case, service unit 170 is a vending machine, an automatic teller machine (ATM), and the like, as described herein above in connection with FIG. 2.

If the transaction value is below the predetermined value, then service unit 170 accepts the transaction, according to the credit card information of magnetic stripe 164, which the user copies to the processor memory of processor 176. Service unit 170 accepts the transaction after confirming that the credit card number of the user does not match a number in the local list of unauthorized credit card numbers stored in look-up table 178. Service unit 170 accepts the transaction without authenticating the user.

If the transaction value is above the predetermined value, then service unit 170 verifies whether the credit card number of the user matches a number in the local list of unauthorized credit card numbers stored in look-up table 178. If the credit card number of the user does not match a number in the local list of unauthorized credit card numbers, then service unit 170 authenticates the user before accepting the transaction. In this authentication process, processor 176 employs the service unit time function and the mobile terminal processor of mobile terminal 150 employs the mobile terminal time function, to produce the first authentication code and the second authentication code, respectively, as described herein above. Processor 176 determines the authenticity of the user, by comparing the first authentication code with the second authentication code. Service unit 170 either accepts or denies the transaction, according to the outcome of the comparison.

In this authentication process, the user communicates with service unit 170, via different combinations of service unit user interface 180, communication interface 174, antenna 156 and the mobile terminal user interface (i.e., speaker 158, display 160, keypad 162 and the microphone). In the first combination, service unit 170 prompts the user via service unit user interface 180, to enter her user secret code to mobile terminal 150. The user enters the user secret code to mobile terminal 150, via the mobile terminal user interface (i.e., keypad 162 or the microphone). The mobile terminal processor produces the second authentication code and reports the second authentication code to the user, via the mobile terminal user interface (i.e., display 160 or speaker 158). The user enters the second authentication code to processor 176, via service unit user interface 180.

In the second combination, service unit 170 prompts the user via service unit user interface 180, to enter her user secret code to mobile terminal 150. The user enters the user secret code to mobile terminal 150, via the mobile terminal user interface (i.e., keypad 162 or the microphone). The mobile terminal processor produces the second authentication code and transmits the second authentication code to processor 176, via antenna 156 and communication interface 174.

In the third combination, service unit 170 establishes communication with mobile terminal 150, via communication interface 174 and antenna 156. Service unit 170 communicates with mobile terminal 150, according to a short-range radio communication protocol, such as Bluetooth, and the like. Service unit 170 prompts the user via the mobile terminal user interface (i.e., speaker 158 or display 160), to enter her user secret code to mobile terminal 150. The user enters the user secret code to mobile terminal 150, via the mobile terminal user interface (i.e., keypad 162 or the microphone). The mobile terminal processor produces the second authentication code and reports the second authentication code to the user, via the mobile terminal user interface (i.e., display 160 or speaker 158). The user enters the second authentication code to processor 176, via service unit user interface 180.

In the fourth combination, service unit 170 establishes communication with mobile terminal 150, via communication interface 174 and antenna 156. Service unit 170 prompts the user via the mobile terminal user interface (i.e., speaker 158 or display 160), to enter her user secret code to mobile terminal 150. The user enters the user secret code to mobile terminal 150, via the mobile terminal user interface (i.e., keypad 162 or the microphone). The mobile terminal processor produces the second authentication code and transmits the second authentication code to processor 176, via antenna 156 and communication interface 174. For this purpose, mobile terminal 150 communicates with service unit 170, according to a short range radio communication protocol, such as Bluetooth, and the like.

It is noted that in case service unit 170 is an ATM, service unit 170 authorizes or denies the transaction according to the requested transaction code, as described herein above in connection with FIG. 2. In this case, service unit 170 either authorizes or denies the transaction, by comparing the requested transaction code, with an authorized list of transaction codes. Service unit 170 determines the requested transaction code according to the type of transaction, which the user requests to perform. The authorized list of transaction codes includes the transaction codes of those transactions which the user is authorized to perform. The list of transaction codes is stored in the credit card storage medium of the credit card.

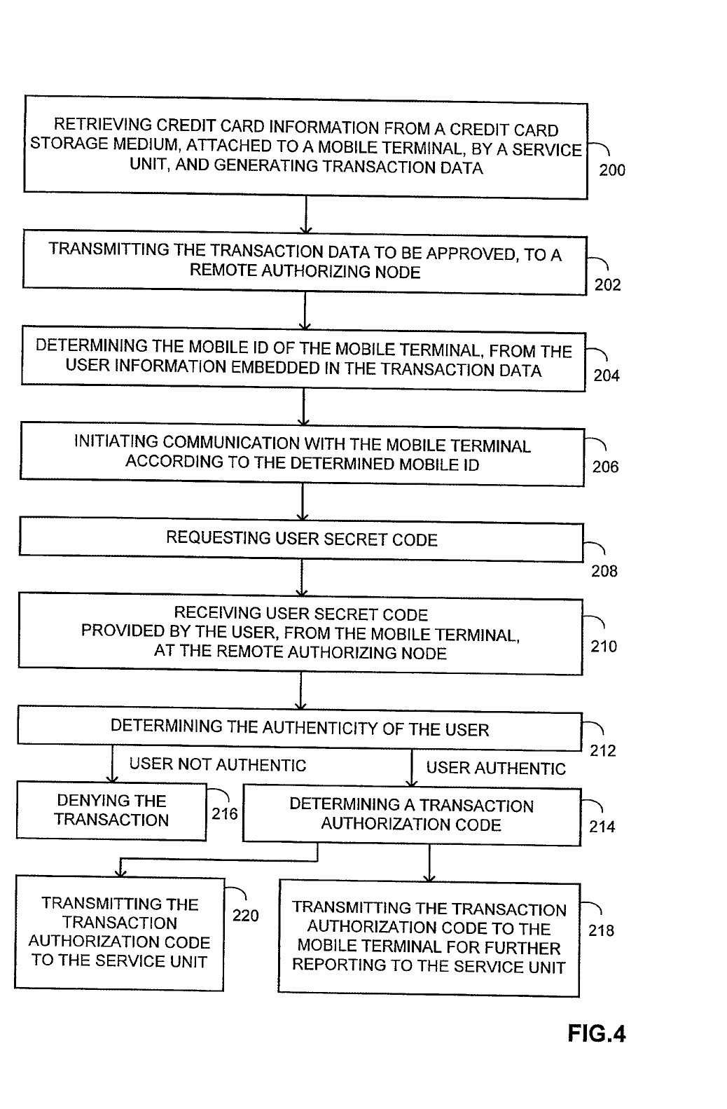

Reference is now made to FIG. 4, which is a schematic illustration of a method to use the mobile terminal of FIG. 2, operative in accordance with a further preferred embodiment of the present invention. In step 200, the credit card information is retrieved from a credit card storage medium attached to a mobile terminal, by a service unit. The credit card storage medium can be a magnetic stripe, a non-volatile memory, and the like. The non-volatile memory is of a type known in the art, such as electrically erasable programmable read only memory (EEPROM), static random access memory (SRAM), dynamic random access memory (DRAM), synchronous dynamic random access memory (SDRAM), and the like. The user can read or write data on the non-volatile medium, via a data transfer interface, such as an electromagnetic interface, an ultraviolet (UV) beam interface, and the like.

With reference to FIG. 2, the user passes edge 114 of flipping cover 110 through card reader 130, whereby card reader 130 copies the credit card information stored on magnetic stripe 112, to the service unit memory of service unit 124.

In step 202, the transaction data which is to be approved, is transmitted to a remote authorizing node. With reference to FIG. 2, service unit 124 transmits to remote authorizing node 122, the credit card number of the user, the user secret code of the user and the user information, via network 120.

In step 204, the mobile ID of the mobile terminal is determined, from the user information embedded in the transaction data. With reference to FIG. 2, processor 126 retrieves the mobile ID of mobile terminal 100 from look-up table 128, according to the credit card number of the user, received from service unit 124.

In step 206, communication with the mobile terminal is initiated, according to the determined mobile ID. With reference to FIG. 2, remote authorizing node 122 initiates communication with mobile terminal 100, according to the mobile ID of mobile terminal 100, as determined in step 204. When the user answers the call by remote authorizing node 122, remote authorizing node 122 requests the user secret code from the user (step 208).

In step 210, the user secret code provided by the user, is received from the mobile terminal, at the remote authorizing node. With reference to FIG. 2, the user enters the user secret code to mobile terminal 100, via the mobile terminal user interface (i.e., keypad 108 or the microphone). Mobile terminal 100 transmits the entered user secret code to remote authorizing node 122, via network 120.

In step 212, the authenticity of the user is determined. With reference to FIG. 2, processor 126 retrieves the user secret code from look-up table 128, according to the credit card number received from service unit 124, in step 202. Processor 126 compares the retrieved user secret code with the user secret code received from mobile terminal 100, in step 210. If the retrieved user secret code is identical with the received user secret code, then processor 126 determines that the user is authentic and further determines a transaction authorization code (step 214). Otherwise, processor 126 determines that the user is not authentic, and further denies the transaction (step 216) and transmits a message respective of the denial, either to service unit 124 or to mobile terminal 100.

In step 218, when the transaction authorization code is determined, the transaction authorization code is transmitted to the mobile terminal, for further reporting to the service unit. With reference to FIG. 2, remote authorizing node 122 sends the transaction authorization code, which was determined in step 214, to mobile terminal 100. Mobile terminal 100 reports the received transaction authorization code to the user, via the mobile terminal user interface (i.e., speaker 104 or display 106). The user, then reports the received transaction authorization code to service unit 124. Alternatively, remote authorizing node 122 transmits the transaction authorization code to service unit 124, via network 120 (step 220).

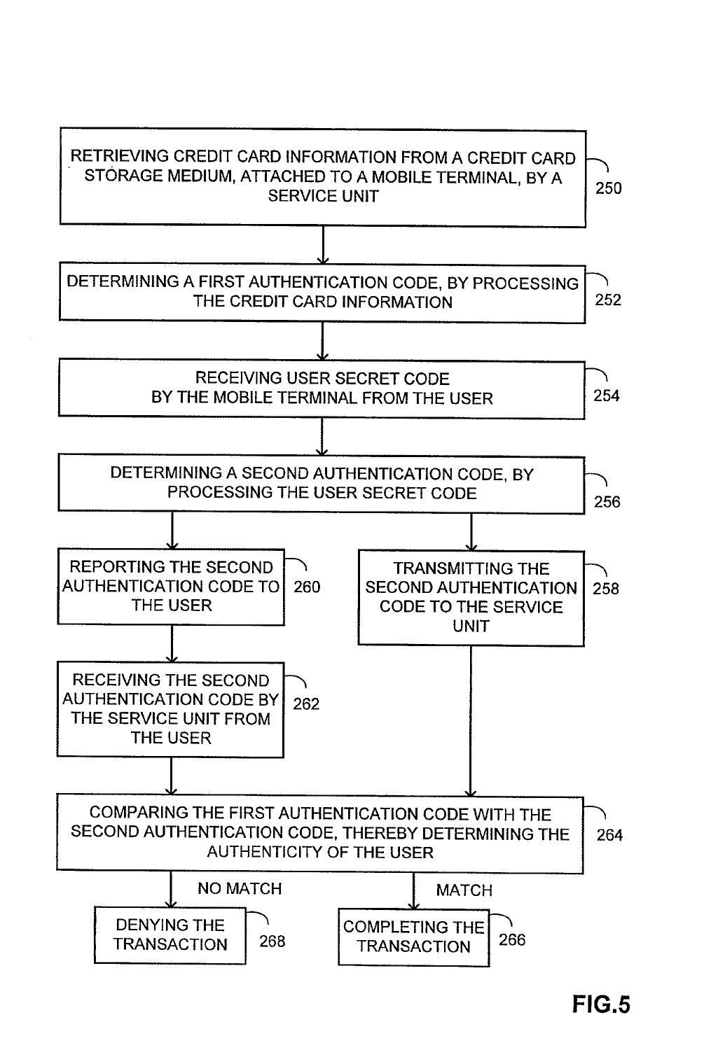

Reference is now made to FIG. 5, which is a schematic illustration of a method to use the mobile terminal of FIG. 3, operative in accordance with another preferred embodiment of the present invention. In step 250, the credit card information is retrieved from a credit card magnetic stripe, attached to a mobile terminal, by a service unit. With reference to FIG. 3, the user passes edge 166 of flipping cover 154, through card reader 168, whereby card reader 168 copies the credit card information embedded in magnetic stripe 164, to the processor memory of processor 176.

In step 252, a first authentication code is determined, by processing the credit card information. With reference to FIG. 3, processor 176 retrieves the user secret code from the processor memory of processor 176, applies the service unit time function to the retrieved user secret code and produces a first authentication code.

In step 254, the user secret code is received from the user, by the mobile terminal. With reference to FIG. 3, the user enters the user secret code to mobile terminal 150, via the mobile terminal user interface (i.e., keypad 162 or the microphone).

In step 256, a second authentication code is determined, by processing the user secret code. With reference to FIG. 3, the processor of mobile terminal 150 applies the mobile terminal time function to the entered user secret code and produces a second authentication code.

In step 258, the second authentication code is transmitted to the service unit. With reference to FIG. 3, mobile terminal 150 transmits the second authentication code to processor 176, via antenna 156 and communication interface 174. Alternatively, in step 260, mobile terminal 150 reports the second authentication code to the user, via the mobile terminal user interface (i.e., speaker 158 or display 160). Then, in step 262, service unit 170 receives the second authentication code, from the user, via service unit user interface 180.

In step 264, the first authentication code is compared with the second authentication code, thereby determining the authenticity of the user. With reference to FIG. 3, processor 176 compares the first authentication code with the second authentication code. If the first authentication code is identical with the second authentication code, then the transaction is completed (step 266). Otherwise, the transaction is denied (step 268).

Following is a description of different embodiments of the present invention, according to which a credit card is connected to a mobile terminal. According to these embodiments, the credit card includes a credit card storage medium, as described herein above in connection with step 200 of FIG. 4. Hence, the credit card storage medium can be a magnetic stripe, a non-volatile memory, and the like. The magnetic stripe includes credit card information. The credit card can be moved from a concealed position or a retracted position, to a released or an extended position, whereby the user can move the magnetic stripe through a card reader. Alternatively, the credit card information is embedded in an integrated circuit (IC), connected to the credit card, whereby the user reads or writes the credit card information to the IC, by interfacing the credit card with a magnetic, electromagnetic or an optical medium. It is noted that the credit card can be either an integral part of the mobile terminal or connected to the mobile terminal by an accessory supplied separate of the mobile terminal. Such an accessory can be a battery compartment, a flipping cover, and the like.

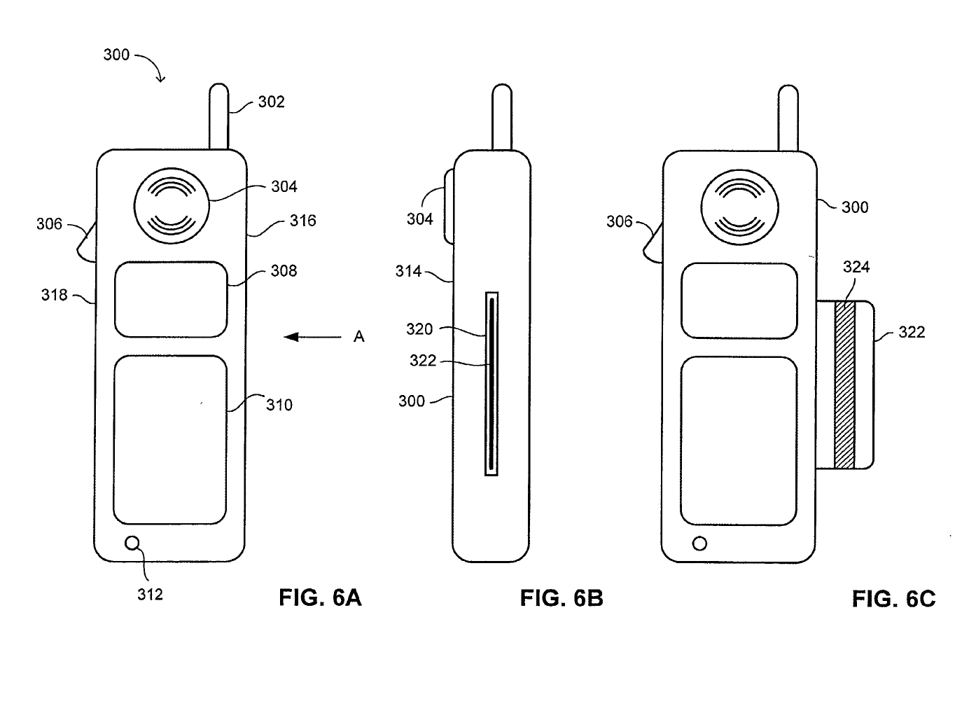

Reference is now made to FIGS. 6A, 6B and 6C. FIG. 6A is a schematic illustration of a mobile terminal, generally referenced 300, constructed and operative in accordance with a further preferred embodiment of the present invention. FIG. 6B is a schematic illustration of view A (right side view) of the mobile terminal of FIG. 6A. FIG. 6C is a schematic illustration of the mobile terminal of FIG. 6A, wherein a credit card is drawn out of the mobile terminal.

Mobile terminal 300 includes an antenna 302, a speaker 304, a card release button 306, a display 308, a keypad 310, a microphone 312, a front side 314, a right side 316, a left side 318, a card slot 320 and a credit card 322. Credit card 322 includes a magnetic stripe 324. Card slot 320 is located in right side 316. Card release button 306 is located on left side 318.

Credit card 322 can move in and out of card slot 320. Credit card 322 is connected to the internal portion of mobile terminal 300, by a mechanical or electromechanical release mechanism. Card release button 306 is further connected to the release mechanism. In the example set forth in FIG. 6A, the release mechanism holds credit card 322 inside mobile terminal 300. When card release button 306 is depressed, credit card 322 is released and draws out of right side 316. When credit card 322 is in drawn out position, the user passes magnetic stripe 324 through a card reader slot (not shown) of a card reader (not shown).

For example, credit card 322 can be held inside mobile terminal 300, by the force of a spring (not shown) acting on a latch (not shown). Depressing card release button 306 removes the spring force from credit card 322 and another spring, forces credit card 322 out of card slot 320. With reference to FIG. 6C, the user can push credit card 322, wherein the spring force acts on the latch and the latch holds credit card 322 inside mobile terminal 300.

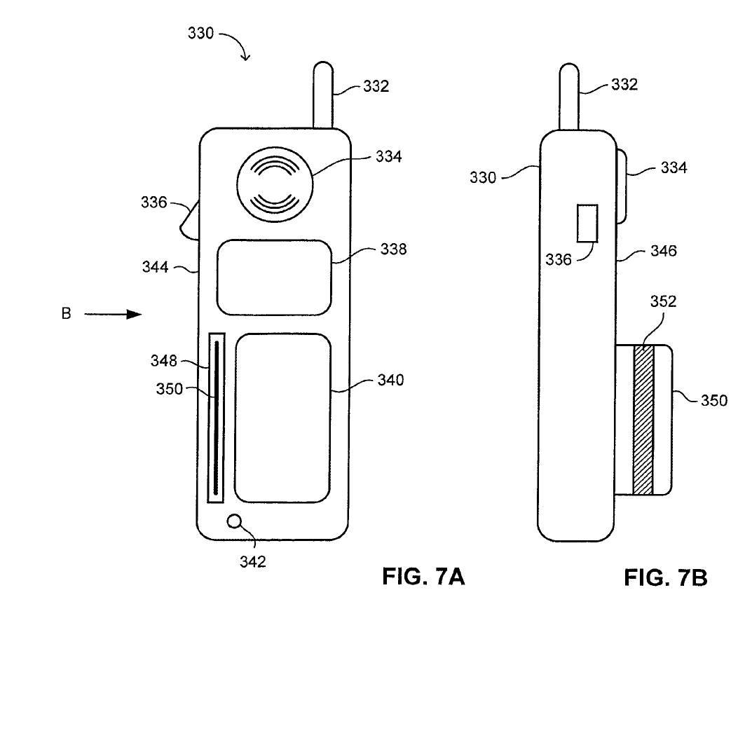

Reference is now made to FIGS. 7A and 7B. FIG. 7A is a schematic illustration of a mobile terminal, generally referenced 330, constructed and operative in accordance with another preferred embodiment of the present invention. FIG. 7B is a schematic illustration of view B (left side view) of the mobile terminal of FIG. 6A.

Mobile terminal 330 includes an antenna 332, a speaker 334, a card release button 336, a display 338, a keypad 340, a microphone 342, a left side 344, a front side 346, a card slot 348 and a credit card 350. Credit card 350 includes a magnetic stripe 352. Card release button 336 is located on left side 344. Card slot 348 is located in front side 346. Credit card 350 can move in and out of card slot 348. Credit card 350 and card release button 336 are connected there between and to mobile terminal 330, as described herein above in connection with FIG. 6A. In the example set forth in FIG. 7A, credit card 350 is held inside mobile terminal 330. In the example set forth in FIG. 7B, credit card 350 is drawn out of card slot 348, by depressing card release button 336. When credit card 350 is drawn out, the user passes magnetic stripe 352 through a card reader slot (not shown) of a card reader (not shown). The user can return credit card 350 to the concealed position, by pushing thereon. Alternatively, the card slot can be located on the rear side of the mobile terminal. Alternatively, the card release button can be located on the right, top, bottom, front or rear side of the mobile terminal.

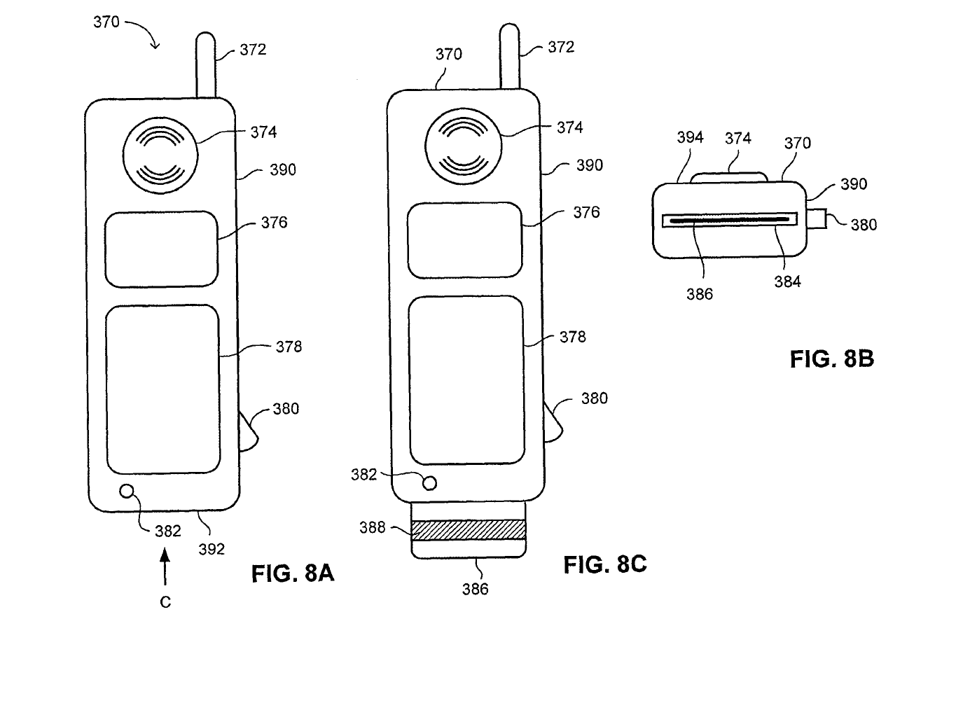

Reference is now made to FIGS. 8A, 8B and 8C. FIG. 8A is a schematic illustration of a mobile terminal, generally referenced 370, constructed and operative in accordance with a further preferred embodiment of the present invention. FIG. 8B is a schematic illustration of view C (bottom view) of the mobile terminal of FIG. 8A. FIG. 8C is a schematic illustration of the mobile terminal of FIG. 8A, wherein a credit card is drawn out of the mobile terminal.

Mobile terminal 370 includes an antenna 372, a speaker 374, a display 376, a keypad 378, a card release button 380, a microphone 382, a card slot 384, a credit card 386, a right side 390, a bottom side 392 and a front side 394. Credit card 386 includes a magnetic stripe 388. Card release button 380 is located on right side 390. Card slot 384 is located in bottom side 392. Credit card 386 can move in and out of card slot 384. Credit card 386 and card release button 380 are connected there between and to mobile terminal 370, as described herein above in connection with FIG. 6A.

In the example set forth in FIG. 8A, credit card 386 is held inside mobile terminal 370. In the example set forth in FIG. 8B, credit card 386 is drawn out of card slot 384, by depressing card release button 380. When credit card 386 is in drawn out, the user passes magnetic stripe 388 through a card reader slot (not shown) of a card reader (not shown). The user can return credit card 386 to the concealed position, by pushing thereon.

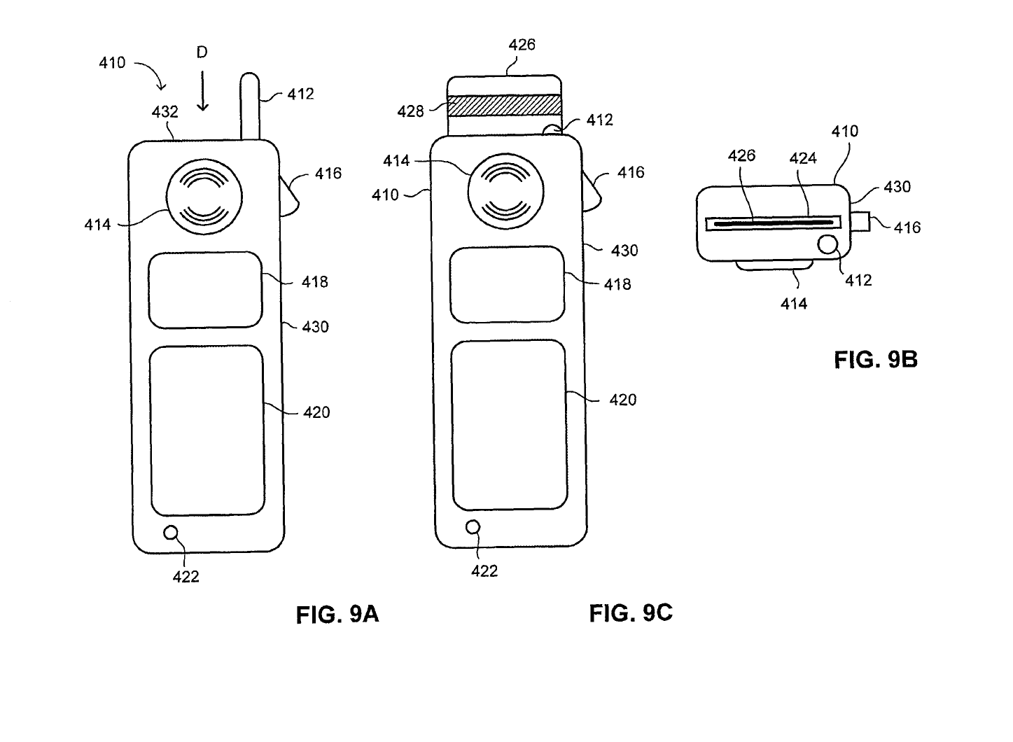

Reference is now made to FIGS. 9A, 9B and 9C. FIG. 9A is a schematic illustration of a mobile terminal, generally referenced 410, constructed and operative in accordance with another preferred embodiment of the present invention. FIG. 9B is a schematic illustration of view D (top view) of the mobile terminal of FIG. 9A. FIG. 9C is a schematic illustration of the mobile terminal of FIG. 9A, wherein a credit card is drawn out of the mobile terminal.

Mobile terminal 410 includes an antenna 412, a speaker 414, a card release button 416, a display 418, a keypad 420, a microphone 422, a card slot 424, a credit card 426, a right side 430 and a top side 432. Credit card 426 includes a magnetic stripe 428. Card release button 416 is located on right side 430. Card slot 424 is located in top side 432. Credit card 426 can move in and out of card slot 424. Credit card 426 and card release button 416 are connected there between and to mobile terminal 410, as described herein above in connection with FIG. 6A.

In the example set forth in FIG. 9A, credit card 426 is held inside mobile terminal 410. In the example set forth in FIG. 9B, credit card 426 is drawn out of card slot 424, by depressing card release button 416 and antenna 412 is in a retracted position. When credit card 426 is in drawn out, the user passes magnetic stripe 428 through a card reader slot (not shown) of a card reader (not shown). The user can return credit card 426 to the concealed position, by pushing thereon.

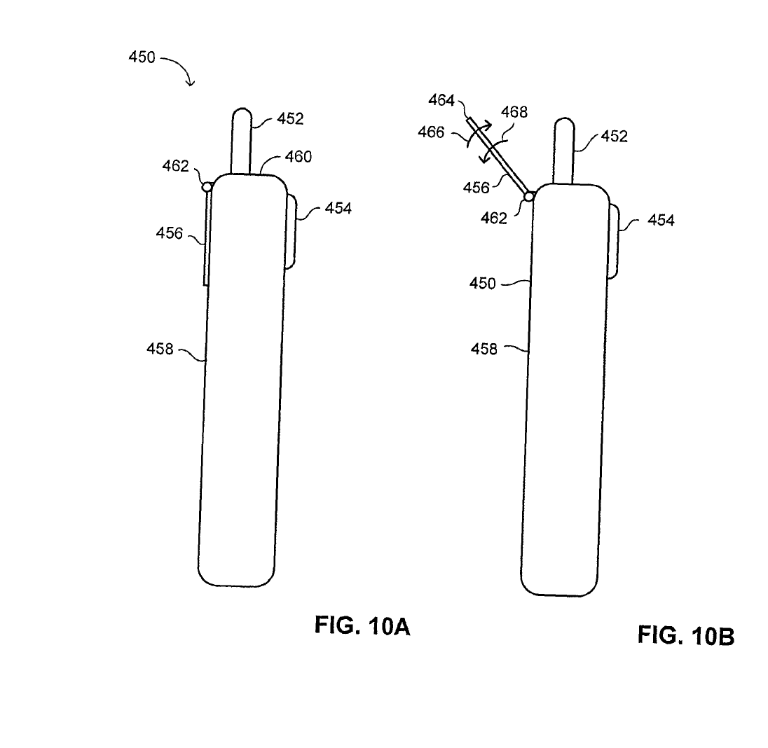

Reference is now made to FIGS. 10A and 10B. FIG. 10A is a schematic illustration of a mobile terminal, generally referenced 450, constructed and operative in accordance with a further preferred embodiment of the present invention. FIG. 10B is a schematic illustration of the mobile terminal of FIG. 10A, with the credit card in an extended position.

Mobile terminal 450 includes an antenna 452, a speaker 454, a credit card 456, a rear face 458 and a top side 460. Credit card 456 includes a magnetic stripe (not shown), located close to an outer edge 464 thereof. Hinge 462 is located substantially at the intersection of top side 460 and rear face 458. Credit card 456 is connected to hinge 462. Credit card 456 is free to rotate about hinge 462 in directions designated by arrows 466 and 468.

The user extends credit card 456, by rotating credit card 456 in direction 466. In this extended position, the user can pass the magnetic stripe through a card reader slot (not shown) of a card reader (not shown). The user can return credit card 456 to a retracted position (as shown in FIG. 10A), by rotating credit card 456 in direction 468. It is noted that a plurality of credit cards can be connected to the mobile terminal through a hinge, whereby the user can rotate and extend a selected credit card and pass the selected credit card through the card reader slot.

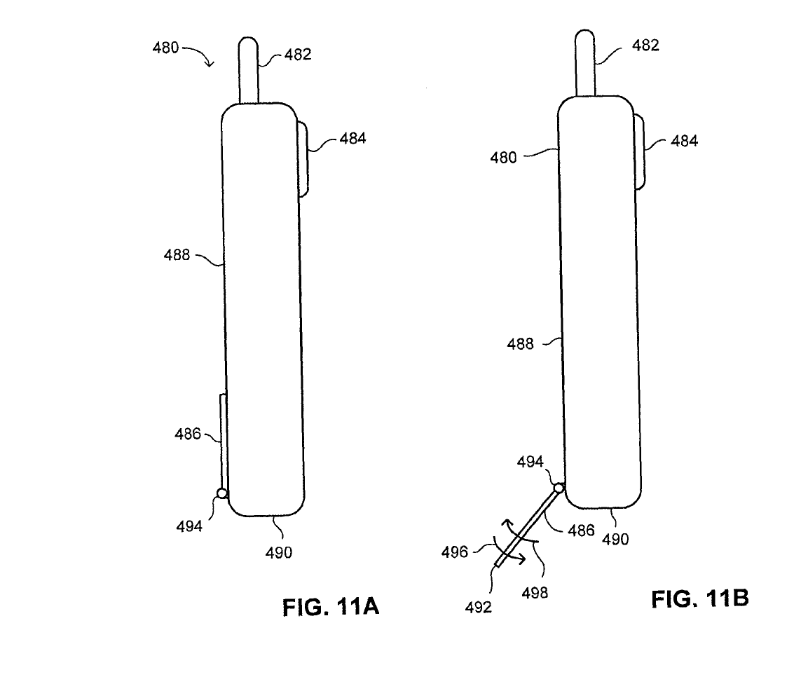

Reference is now made to FIGS. 11A and 11B. FIG. 11A is a schematic illustration of a mobile terminal, generally referenced 480, constructed and operative in accordance with another preferred embodiment of the present invention. FIG. 11B is a schematic illustration of the mobile terminal of FIG. 11A, with the credit card in an extended position.

Mobile terminal 480 includes an antenna 482, a speaker 484, a credit card 486, a rear face 488 and a bottom side 490. Credit card 486 includes a magnetic stripe (not shown), located close to an outer edge 492 thereof. Hinge 494 is located substantially at the intersection of bottom side 490 and rear face 488. Credit card 486 is connected to hinge 494. Credit card 486 is free to rotate about hinge 494 in directions designated by arrows 496 and 498.

The user extends credit card 486, by rotating credit card 486 in direction 496. In this extended position, the user can pass the magnetic stripe through a card reader slot (not shown) of a card reader (not shown). The user can return credit card 486 to a retracted position (as shown in FIG. 11A), by rotating credit card 486 in direction 498.

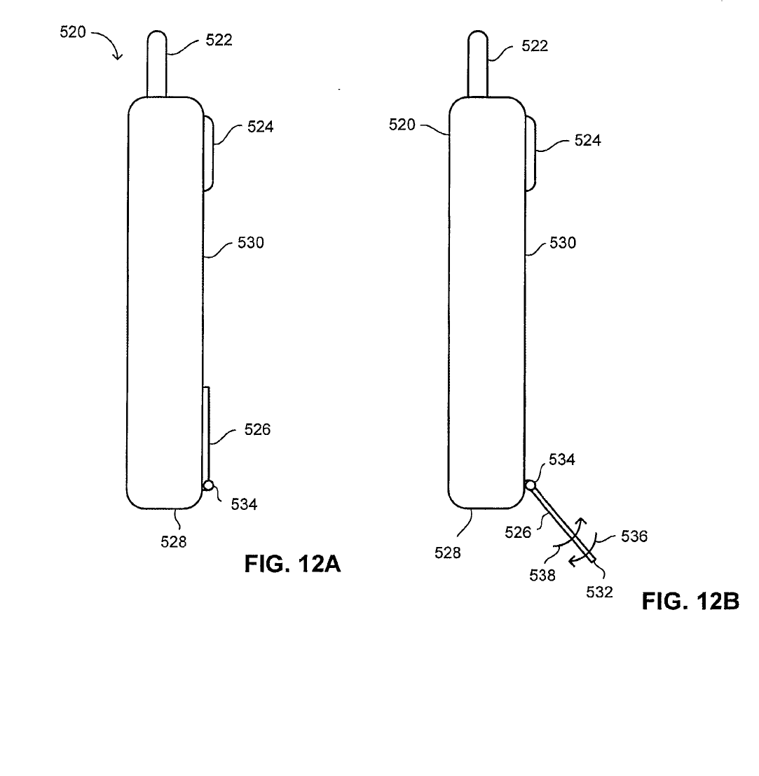

Reference is now made to FIGS. 12A and 12B. FIG. 12A is a schematic illustration of a mobile terminal, generally referenced 520, constructed and operative in accordance with a further preferred embodiment of the present invention. FIG. 12B is a schematic illustration of the mobile terminal of FIG. 12A, with the credit card in an extended position.

Mobile terminal 520 includes an antenna 522, a speaker 524, a credit card 526, a bottom side 528 and a front side 530. Credit card 526 includes a magnetic stripe (not shown), located close to an outer edge 532 thereof. Hinge 534 is located substantially at the intersection of bottom side 528 and front side 530. Credit card 526 is connected to hinge 534. Credit card 526 is free to rotate about hinge 534 in directions designated by arrows 536 and 538.

The user extends credit card 526, by rotating credit card 526 in direction 536. In this extended position, the user can pass the magnetic stripe through a card reader slot (not shown) of a card reader (not shown). The user can return credit card 526 to a retracted position (as shown in FIG. 12A), by rotating credit card 526 in direction 538.

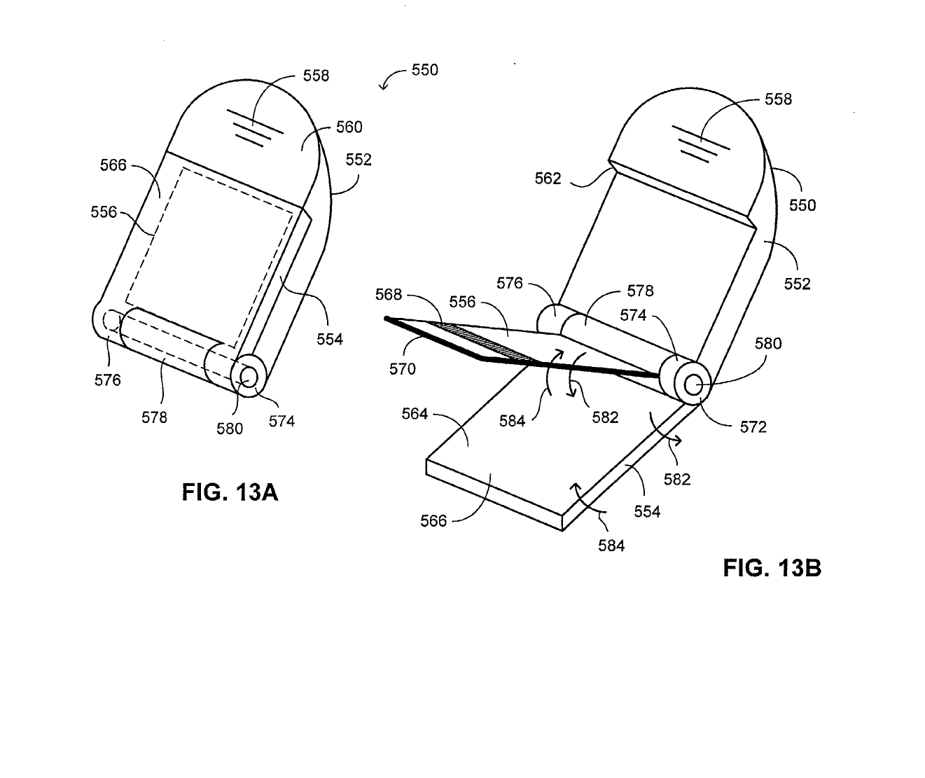

Reference is now made to FIGS. 13A and 13B. FIG. 13A is a schematic illustration of a mobile terminal, generally referenced 550, constructed and operative in accordance with another preferred embodiment of the present invention. FIG. 13B is a schematic illustration of the mobile terminal of FIG. 13A, with the credit card in an extended position.

Mobile terminal 550 is a flip-phone type terminal. Mobile terminal 550 includes a headset 552, a flipping cover 554 and a credit card 556. Headset 552 includes a speaker 558, a speaker surface 560 a recess 562 and a microphone (not shown). Recess 562 includes a user interface (not shown), such as a keypad, a display, and the like. Flipping cover 554 includes a front surface 564 and a rear surface 566. Front surface 564 is the surface of flipping cover 554, which points toward the mouth of the user (not shown). Rear surface 566 is the surface opposite to front surface 564. Flipping cover 554 includes a microphone (not shown), on front surface 564. Credit card 556 includes a magnetic stripe 568 substantially close to an outer edge 570 thereof.

Flipping cover 554 and credit card 556 are connected to headset 552 via a hinge 572. Hinge 572 includes two flipping cover hollow shafts 574 and 576, a credit card hollow shaft 578 and a round rod 580. Round rod 580 is located inside flipping cover hollow shafts 574 and 576, and credit card hollow shaft 578. Flipping cover hollow shafts 574 and 576 are connected to headset 552 and to flipping cover 554. Credit card hollow shaft 578 is connected to credit card 556 and to headset 552. Flipping cover 554 is free to rotate about hinge 572 in directions designated by arrows 582 and 584, relative to headset 552 and credit card 556. Credit card 556 is free to rotate about hinge 572 in directions designated by arrows 582 and 584, relative to headset 552 and flipping cover 554. Credit card 556 is located between recess 562 and flipping cover 554.

When mobile terminal 550 is in closed position (i.e., FIG. 13A), credit card 556 rests between recess 562 and front surface 564, and rear surface 566 is substantially flush with speaker surface 560. The user opens mobile terminal 550, by rotating flipping cover 554 and credit card 556, in direction 582. The user rotates credit card 556 in direction 582, such that credit card 556 rests on front surface 564. In this position, the user can initiate a call by using the user interface which is located in recess 562. The user rotates credit card 556 in direction 582, such that credit card 556 rests in recess 562. In this position, the user can communicate by speaking to the microphone and hearing through speaker 558.

The user rotates credit card 556 to an intermediate position (FIG. 13B). In this position, the user can pass magnetic stripe 568 through a card reader slot (not shown) of a card reader (not shown).

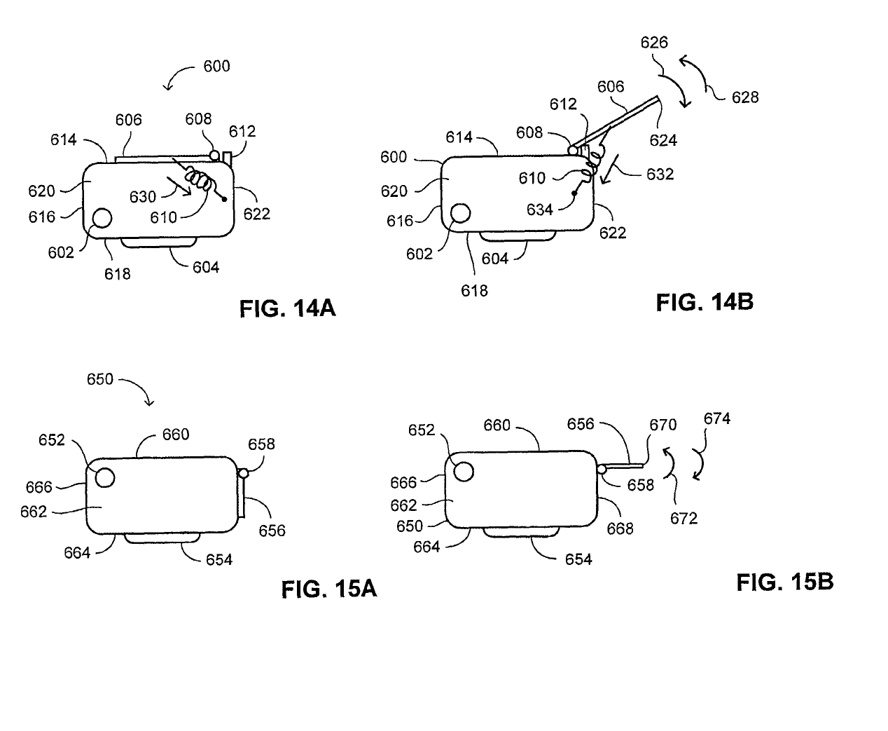

Reference is now made to FIGS. 14A and 14B. FIG. 14A is a schematic illustration of the top view of a mobile terminal, generally referenced 600, constructed and operative in accordance with a further preferred embodiment of the present invention. FIG. 14B is a schematic illustration of the mobile terminal of FIG. 14A, with the credit card in an extended position.

Mobile terminal 600 includes an antenna 602, a speaker 604, a credit card 606, a hinge 608, a spring element 610, a stop 612, a rear face 614, a left side 616, a front side 618, a top side 620 and a right side 622. Credit card 606 includes a magnetic stripe (not shown), substantially close to an outer edge 624 thereof. Spring element 610 is a helical spring, a leaf spring, and the like.

Antenna 602 is located on top side 620, between front side 618 and left side 616. Speaker 604 is located on front side 618. Stop 612 is located at the intersection of rear face 614 and right side 622, substantially close to top side 620.

Hinge 608 is connected to rear face 614, in close proximity to right side 622. Credit card 606 is connected to hinge 608. Spring element 610 is connected to top side 620 at a spring-to-terminal attachment point 634 substantially close to right side 622. Spring element 610 is further connected to credit card 606. Credit card 606 is free to rotate about hinge 608 in directions designated by arrows 626 and 628.

With reference to FIG. 14A, spring element 610 applies a spring force on credit card 606, in a direction designated by an arrow 630. Thus, credit card 606 remains in retracted position, in contact with rear face 614. With reference to FIG. 14B, the user rotates credit card 606 in direction 626, whereby credit card 606 toggles to an extended position, with the aid of spring element 610. In this extended position, spring element 610 applies another spring force on credit card 606 in a direction designated by an arrow 632. Stop 612 prevents credit card 606 to rotate any further and maintains credit card 606 in this extended position. Thus, the user can pass the magnetic stripe through a card reader slot (not shown) of a card reader (not shown).

The user returns credit card 606 to the retracted position (FIG. 14A), by rotating credit card 606 in direction 628. Credit card 606 toggles to the retracted position, with the aid of spring element 610. In the example set forth in FIGS. 14A and 14B, spring element 610 is located external to mobile terminal 600. However, it is noted that spring element 610 can be located inside mobile terminal 600.

Alternatively, the spring-to-terminal attachment point is located inside the mobile terminal, between top side 620 and a bottom side of the mobile terminal (not shown). Alternatively, stop 612 is located at the intersection of right side 622 and rear face 614, between top side 620 and the bottom side. Alternatively, the spring-to-terminal attachment point is located substantially close to left side 616, the hinge is connected to rear face 614 substantially close to left side 616 and the stop is located at the intersection of rear face 614 and left side 616.

Alternatively, the spring-to-terminal attachment point is located substantially close to right side 622 and between top side 620 and the bottom side. Furthermore, the hinge is connected to front side 618, substantially close to right side 622, between top side 620 and the bottom side. Furthermore, the stop is located at the intersection of front side 618 and right side 622, between top side 620 and the bottom side.

Alternatively, the spring-to-terminal attachment point is located substantially close to left side 616 and between top side 620 and the bottom side. Furthermore, the hinge is connected to front side 618, substantially close to left side 616, between top side 620 and the bottom side. Furthermore, the stop is located at the intersection of front side 618 and left side 616, between top side 620 and the bottom side.

Reference is now made to FIGS. 15A and 15B. FIG. 15A is a schematic illustration of the top view of a mobile terminal, generally referenced 650, constructed and operative in accordance with another preferred embodiment of the present invention. FIG. 15B is a schematic illustration of the mobile terminal of FIG. 15A, with the credit card in an extended position.

Mobile terminal 650 includes an antenna 652, a speaker 654, a credit card 656, a hinge 658, a rear face 660, a top side 662, a front side 664, a left side 666 and a right side 668. Credit card 656 includes a magnetic stripe (not shown), substantially close to an outer edge 670 thereof.

Hinge 658 is connected to right side 668 substantially close to rear face 660. Credit card 656 is connected to hinge 658. Credit card 656 is free to rotate about hinge 658 in directions designated by arrows 672 and 674.

The user extends credit card 656 by rotating credit card 656 in direction 670. In this extended position (FIG. 15B), the user can pass the magnetic stripe through a card reader slot (not shown) of a card reader (not shown). The user can return credit card 656 to the retracted position (FIG. 15A), by rotating credit card 656 in direction 674.

Alternatively, the hinge is connected to right side 668 substantially close to front side 664. Alternatively, the hinge is connected to left side 666 substantially close to rear face 660. Alternatively, the hinge is connected to left side 666 substantially close to front side 664.

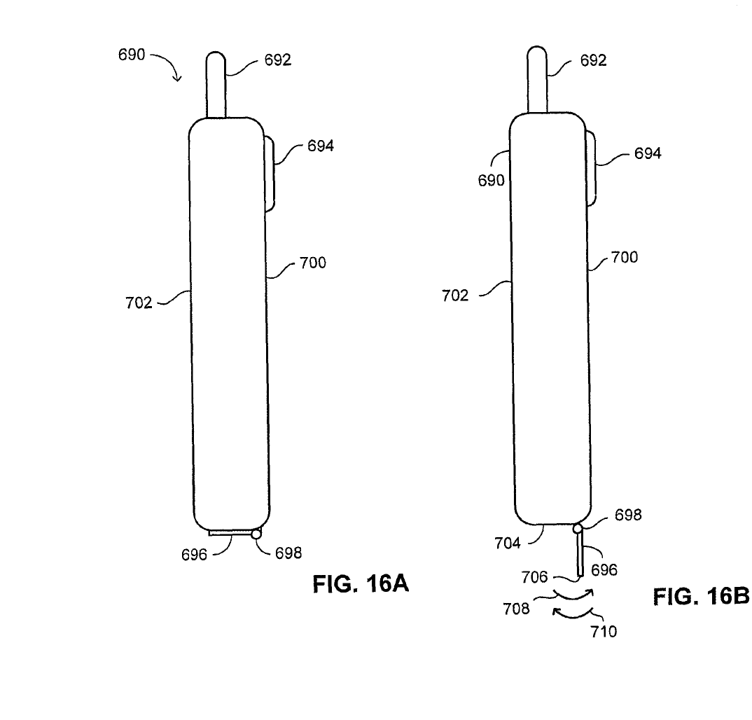

Reference is now made to FIGS. 16A and 16B. FIG. 16A is a schematic illustration of a mobile terminal, generally referenced 690, constructed and operative in accordance with a further preferred embodiment of the present invention. FIG. 16B is a schematic illustration of the mobile terminal of FIG. 16A, with the credit card in an extended position.

Mobile terminal 690 includes an antenna 692, a speaker 694, a credit card 696, a hinge 698, a front side 700, a rear face 702 and a bottom side 704. Credit card 696 includes a magnetic stripe (not shown) substantially close to an outer edge 706 thereof. Hinge 698 is connected to bottom side 704, substantially close to front side 700. Credit card 696 is connected to hinge 698. Credit card 696 is free to rotate about hinge 698 in directions designated by arrows 708 and 710.

The user rotates credit card 696 in direction 708, thereby extending credit card 696. In this extended position (FIG. 16B), the user can pass the magnetic stripe through a card reader slot (not shown) of a card reader (not shown). The user can return credit card 696 to the retracted position (FIG. 16A), by rotating credit card 696 in direction 710. Alternatively, the hinge is connected to bottom side 704, substantially close to rear face 702.

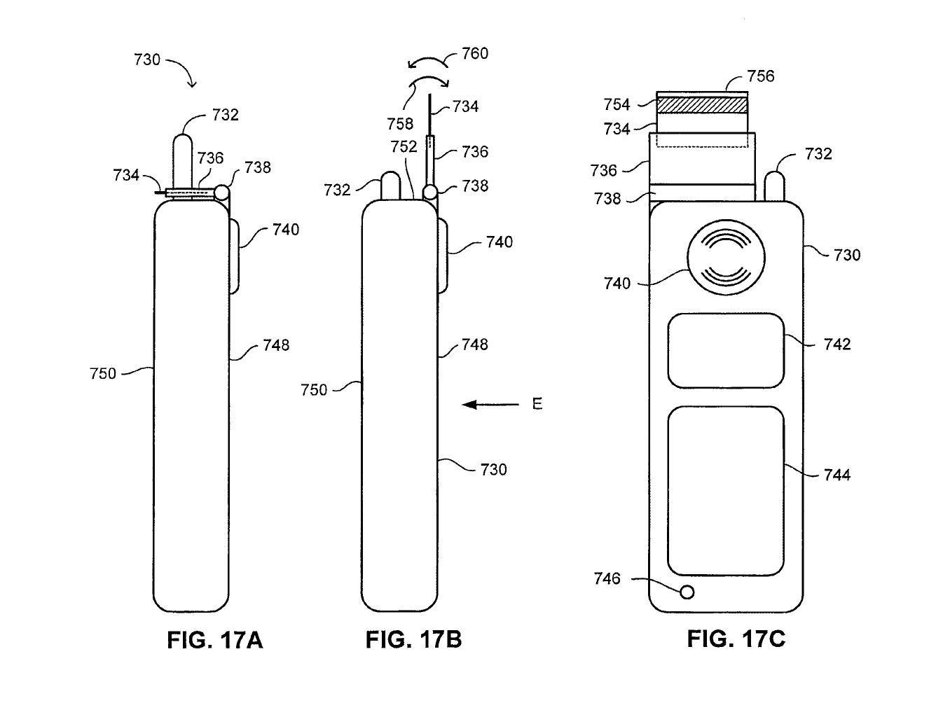

Reference is now made to FIGS. 17A, 17B and 17C. FIG. 17A is a schematic illustration of the side view of a mobile terminal, generally referenced 730, constructed and operative in accordance with another preferred embodiment of the present invention. FIG. 17B is a schematic illustration of the mobile terminal of FIG. 17A, with the credit card in an extended position. FIG. 17C is a schematic illustration of view E (front view) of the mobile terminal of FIG. 17B.

Mobile terminal 730 includes an antenna 732, a credit card 734, a credit card holder 736, a hinge 738, a speaker 740, a display 742, a keypad 744, a microphone 746, a front side 748, a rear face 750 and a top side 752. Credit card 734 includes a magnetic stripe 754 substantially close to an outer edge 756 thereof. Credit card holder 736 includes a card holder slot (not shown). Hinge 738 is located substantially at the intersection of top side 752 and front side 748. Credit card holder 736 is connected to hinge 738.

Credit card 734 is located in credit card holder 736 and can partially slide in and out of credit card holder 736, through the card holder slot of credit card holder 736. Each of credit card 734 and the card holder slot of credit card holder 736 includes a stop, which prevent credit card 734 to completely slide out of the card holder slot. Credit card holder 736 is free to rotate about hinge 738 in directions designated by arrows 758 and 760.

The user extends credit card 734 by rotating credit card holder 736 in direction 758, sliding credit card 734 out of credit card holder 736 and retracting antenna 732 (FIGS. 17B and 17C). In this extended position, the user can pass magnetic stripe 754 through a card reader slot (not shown) of a card reader (not shown).

The user can return credit card 734 to the retracted position (FIG. 17A), by sliding credit card 734 into credit card holder 736 and rotating credit card holder 736 in direction 760. Alternatively, hinge 738 is located substantially at the intersection of top side 752 and rear face 750.

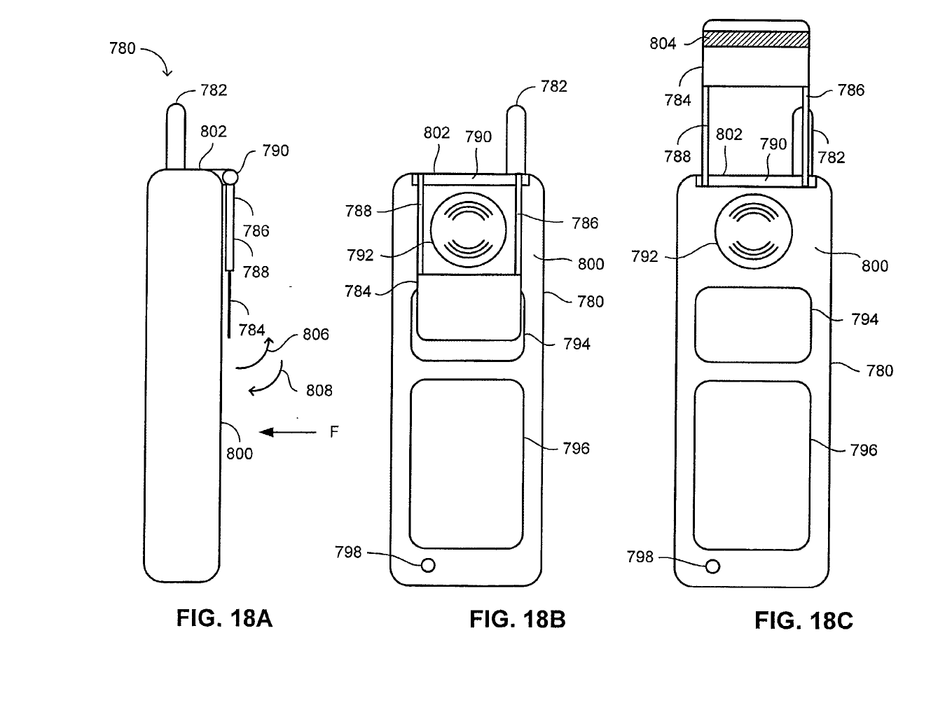

Reference is now made to FIGS. 18A, 18B and 18C. FIG. 18A is a schematic illustration of the side view of a mobile terminal, generally referenced 780, constructed and operative in accordance with a further preferred embodiment of the present invention. FIG. 18B is a schematic illustration of view F (front view) of the mobile terminal of FIG. 18A. FIG. 18C is a schematic illustration of the mobile terminal of FIG. 18B, with the credit card in an extended position.

Mobile terminal 780 includes an antenna 782, a credit card 784, a right arm 786, a left arm 788, a hinge 790, a speaker 792, a display 794, a keypad 796, a microphone 798, a front side 800 and a top side 802. Credit card 784 includes a magnetic stripe 804. Hinge 790 is located substantially at the intersection of top side 802 and front side 800. Right arm 786 and left arm 788 are connected to hinge 790 and to credit card 784. Right arm 786 and left arm 788 are free to rotate together, about hinge 790, in directions designated by arrows 806 and 808.

When credit card 784 is in retracted position (FIGS. 18A and 18B), the user can hear the sound of speaker 792 through the opening between hinge 790, right arm 786, left arm 788 and credit card 784. The user extends credit card 784, by rotating credit card 784 in direction 806. In this extended position (FIG. 18C), the user can pass magnetic stripe 804 through a card reader slot (not shown) of a card reader (not shown). The user can return credit card 784 to the retracted position (FIGS. 18A and 18B), by rotating credit card 784 in direction 808.

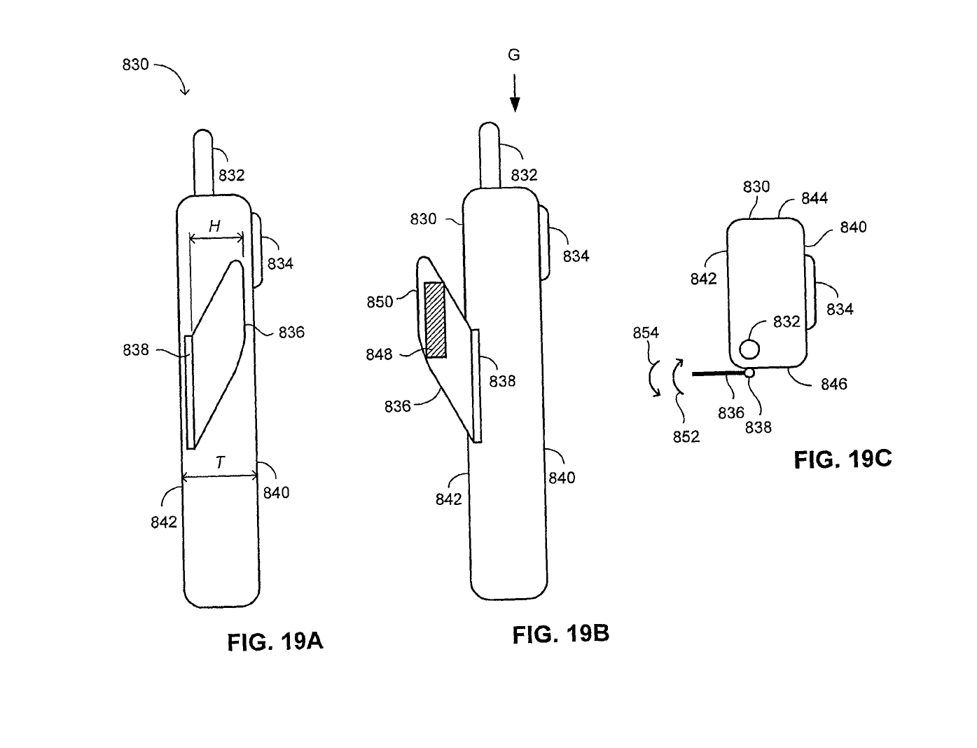

Reference is now made to FIGS. 19A, 19B and 19C. FIG. 19A is a schematic illustration of the side view of a mobile terminal, generally referenced 830, constructed and operative in accordance with another preferred embodiment of the present invention. FIG. 19B is a schematic illustration of the mobile terminal of FIG. 19A, with the credit card in an extended position. FIG. 19C is a schematic illustration of view G (top view) of the mobile terminal of FIG. 19B.

Mobile terminal 830 includes an antenna 832, a speaker 834, a credit card 836, a hinge 838, a front side 840, a rear face 842, a right side 844 and a left side 846. Credit card 836 includes a magnetic stripe 848 at an outer edge 850 thereof. Hinge 838 is located substantially at the intersection of left side 846 and rear face 842. Credit card 836 is connected to hinge 838. Credit card 836 is free to rotate about hinge 838 in directions designated by arrows 852 and 854.

The longitudinal axis of hinge 838 is substantially parallel with the longitudinal axis of mobile terminal 830. Credit card 836 is in shape of a parallelogram. The parallelogram has a height H. Mobile terminal 830 has a thickness T, where H<T. The longitudinal axis of magnetic stripe 848 is substantially parallel with the longitudinal axis of hinge 838.

The user rotates credit card 836 in direction 852, thereby extending credit card 836. In this extended position (FIGS. 19B and 19C), the user can pass magnetic stripe 848 through a card reader slot (not shown) of a card reader (not shown). The user can return credit card 836 to the retracted position (FIG. 19A), by rotating credit card 836 in direction 854.

Alternatively, hinge 838 is located substantially at the intersection of left side 846 and front side 840. Alternatively, hinge 838 is located substantially at the intersection of right side 844 and front side 840. Alternatively, hinge 838 is located substantially at the intersection of right side 844 and rear face 842.

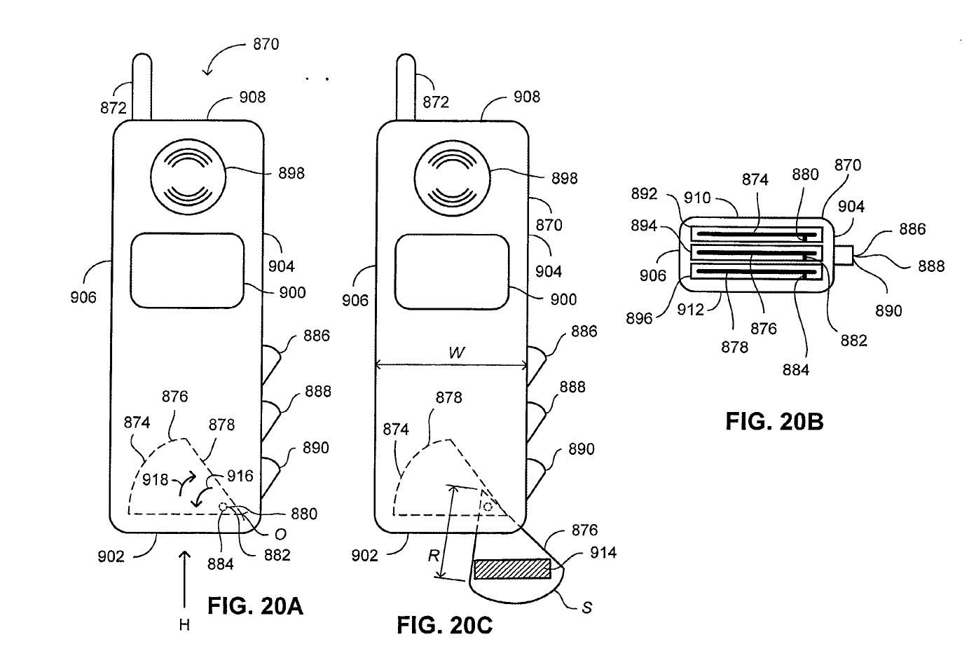

Reference is now made to FIGS. 20A, 20B and 20C. FIG. 20A is a schematic illustration of a mobile terminal, generally referenced 870, constructed and operative in accordance with a further preferred embodiment of the present invention. FIG. 20B is a schematic illustration of view H (bottom view) of the mobile terminal of FIG. 20A. FIG. 20C is a schematic illustration of the mobile terminal of FIG. 20A, with a credit card in an extended position.

Mobile terminal 870 includes an antenna 872, a plurality of credit cards 874, 876 and 878, a plurality of hinges 880, 882 and 884, a plurality of card release buttons 886, 888 and 890, a plurality of card slots 892, 894 and 896, a speaker 898, a display 900, a bottom side 902, a right side 904, a left side 906, a top side 908, a front side 910 and a rear face 912. Each of credit cards 874, 876 and 878, includes a magnetic stripe, such as magnetic stripe 914 on credit card 876. Each of credit cards 874, 876 and 878 is in shape of a segment of a circle having a radius R and a center O. Mobile terminal 870 had a width W, wherein R<W. Each of credit cards 874, 876 and 878 includes an arc S of the circle. Each magnetic stripe is located substantially close to arc S.

Card slots 892, 894 and 896 are located in bottom side 902. Credit cards 874, 876 and 878 are connected to hinges 880, 882 and 884, respectively. Each of hinges 880, 882 and 884 is connected to a release mechanism similar to the release mechanism as described herein above in connection with FIG. 6A. Hinges 880, 882 and 884 are located inside card slots 892, 894 and 896, respectively, substantially close to right side 904. Credit cards 874, 876 and 878 can rotate freely about hinges 880, 882 and 884, respectively, in directions designated by arrows 916 and 918. Card release buttons 886, 888 and 890 are located on right side 904. Each of card release buttons 886, 888 and 890 is connected to a release mechanism (not shown) of the respective one of hinges 880, 882 and 884.

When credit cards 874, 876 and 878 rotate in direction 916, credit cards 874, 876 and 878 slide out of card slots 892, 894 and 896, respectively. When credit cards 874, 876 and 878 rotate in direction 918, credit cards 874, 876 and 878 slide back into card slots 892, 894 and 896, respectively. When the user presses card release button 886, 888 or 890, the respective release mechanism releases credit card 874, 876 or 878, respectively, and credit card 874, 876 or 878 slides out of card slot 892, 894 or 896, respectively, to an extended position.

For example, the user presses card release button 888, whereby the release mechanism releases credit card 876, credit card 876 rotates in direction 916 and slides out of card slot 894, to the extended position shown in FIG. 20C. In this extended position, the user can pass magnetic stripe 914 through a card reader slot (not shown) of a card reader (not shown). The user can return credit card 876 to the retracted position (FIG. 20A), by pressing credit card 876 into card slot 894, whereby the respective release mechanism holds credit card 876 inside mobile terminal 870.

Alternatively, card slots 892, 894 and 896 are integrated into one card slot (not shown). It is noted that each of card release buttons 886, 888 and 890, and each of card slots 892, 894 and 896, can be located on either right side 904, left side 906, bottom side 902 or top side 908.

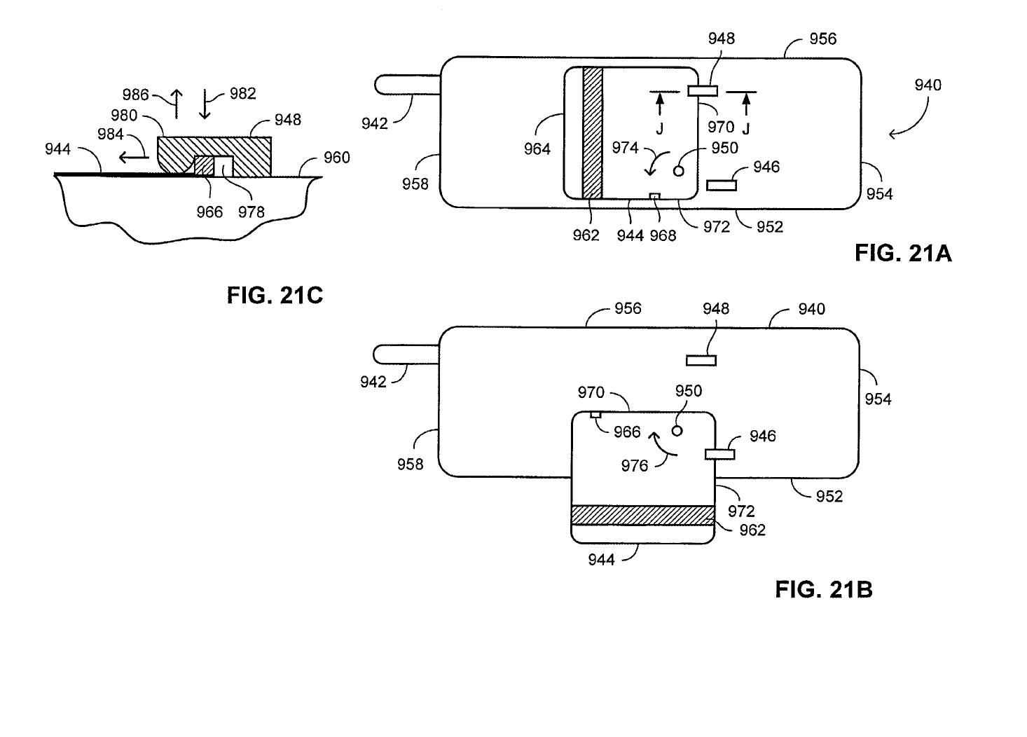

Reference is now made to FIGS. 21A, 21B and 21C. FIG. 21A is a schematic illustration of the rear view of a mobile terminal, generally referenced 940, constructed and operative in accordance with another preferred embodiment of the present invention. FIG. 21B is a schematic illustration of the mobile terminal of FIG. 21A, with the credit card in an extended position. FIG. 21C is a schematic illustration of section J-J (latch mechanism) of the mobile terminal of FIG. 21A.

Mobile terminal 940 includes an antenna 942, a credit card 944, a right latch 946, a left latch 948, a hinge 950, a right side 952, a bottom side 954, a left side 956, a top side 958 and a rear face 960. Credit card 944 includes a magnetic stripe 962 located substantially at an outer edge 964 thereof. Credit card 944 further includes a left protrusion 966 and a right protrusion 968.

Right latch 946 is connected to rear face 960, substantially close to right side 952. Left latch 948 is connected to rear face 960, substantially close to left side 956. Hinge 950 is connected to rear face 960, substantially close to right latch 946. Left protrusion 966 is located at an edge 970 of credit card 944. Right protrusion 968 is located at an edge 972 of credit card 944. Credit card 944 is connected to hinge 950. When credit card 944 is not latched by neither right latch 946, nor by left latch 948, credit card 944 can rotate freely about hinge 950, in directions designated by arrows 974 and 976.

With reference to FIGS. 21A and 21C, when credit card 944 is in the retracted position, left protrusion 966 is located in a recess 978 of left latch 948. In this retracted position, a hook portion 980 of left latch 948, applies a latching force designated by an arrow 982, on left protrusion 966 thereby preventing credit card 944 to rotate in direction 974.

When the user rotates credit card 944 in direction 974, left protrusion 966 applies a force designated by an arrow 984, on hook portion 980, thereby forcing hook portion 980 in a direction designated by an arrow 986. Further rotation of credit card 944 in direction 974, releases credit card 944 from left latch 948. Further rotation of credit card 944 in direction 974, causes right protrusion 968 to enter another recess (not shown) of right latch 946, in a process opposite to the one illustrated in FIG. 21C. Thus, right latch 946 keeps credit card 944 in an extended position (FIG. 21B). In this extended position, the user can pass magnetic stripe 962 through a card reader slot (not shown) of a card reader (not shown). The user can return credit card 944 to the retracted position (FIG. 21A), by rotating credit card 944 in direction 976 and entering left protrusion 966 into left latch 948. Alternatively, the hinge is connected to credit card 944.

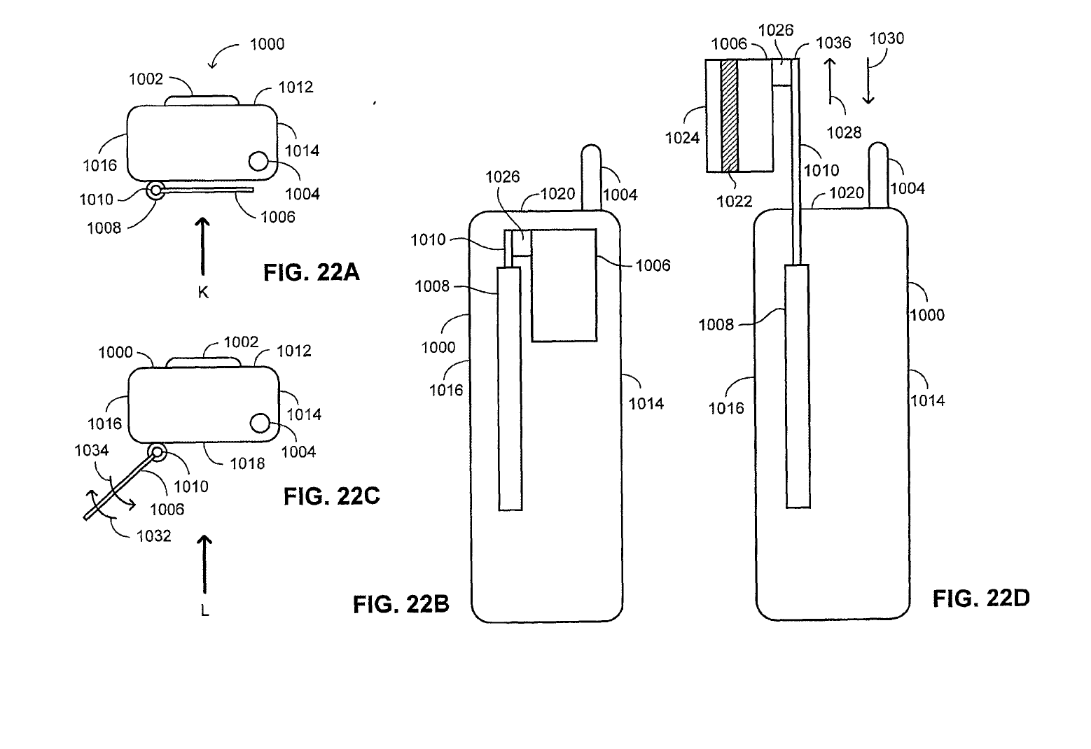

Reference is now made to FIGS. 22A, 22B, 22C and 22D. FIG. 22A is a schematic illustration of the top view of a mobile terminal, generally referenced 1000, constructed and operative in accordance with a further preferred embodiment of the present invention. FIG. 22B is a schematic illustration of view K (rear view) of the mobile terminal of FIG. 22A. FIG. 22C is a schematic illustration of the mobile terminal of FIG. 22A, with the credit card in an extended position. FIG. 22D is a schematic illustration of view L (rear view) of the mobile terminal of FIG. 22C.

Mobile terminal 1000 includes a speaker 1002, an antenna 1004, a credit card 1006, an outer telescopic rod 1008, a front side 1012, a left side 1014, a right side 1016, a rear face 1018 and a top side 1020. Credit card 1006 includes a magnetic stripe 1022 at an outer edge 1024 thereof. Credit card 1006 includes a protruding narrow section 1026. Outer telescopic rod 1008 includes an inner telescopic rod 1010.

Outer telescopic rod 1008 is connected to rear face 1018, such that the longitudinal axis of outer telescopic rod 1008 is substantially parallel with the longitudinal axis of mobile terminal 1000. Outer telescopic rod 1008 is located substantially close to right side 1016. Inner telescopic rod 1010 can be extended out of outer telescopic rod 1008, in a direction designated by an arrow 1028. Inner telescopic rod 1010 can be retracted into outer telescopic rod 1008, in a direction designated by an arrow 1030. Inner telescopic rod 1010 is free to rotate inside outer telescopic rod 1008, in directions designated by arrows 1032 and 1034. Protruding narrow section 1026 is connected to an end 1036 of inner telescopic rod 1010.

The user rotates credit card 1006 in direction 1032 and pulls credit card 1006 in direction 1028, thereby extending credit card 1006 (FIGS. 22C and 22D). In this extended position, the user can pass magnetic stripe 1022 through a card reader slot (not shown) of a card reader (not shown). The user can return credit card 1006 to the retracted position (FIGS. 22A and 22B), by rotating credit card 1006 in direction 1034 and pushing credit card 1006 in direction 1030. Alternatively, outer telescopic rod 1008 is connected to rear face 1018, such that inner telescopic rod 1010 extends in direction 1030 and retracts in direction 1028. Alternatively, the inner telescopic rod includes further telescopic rods.

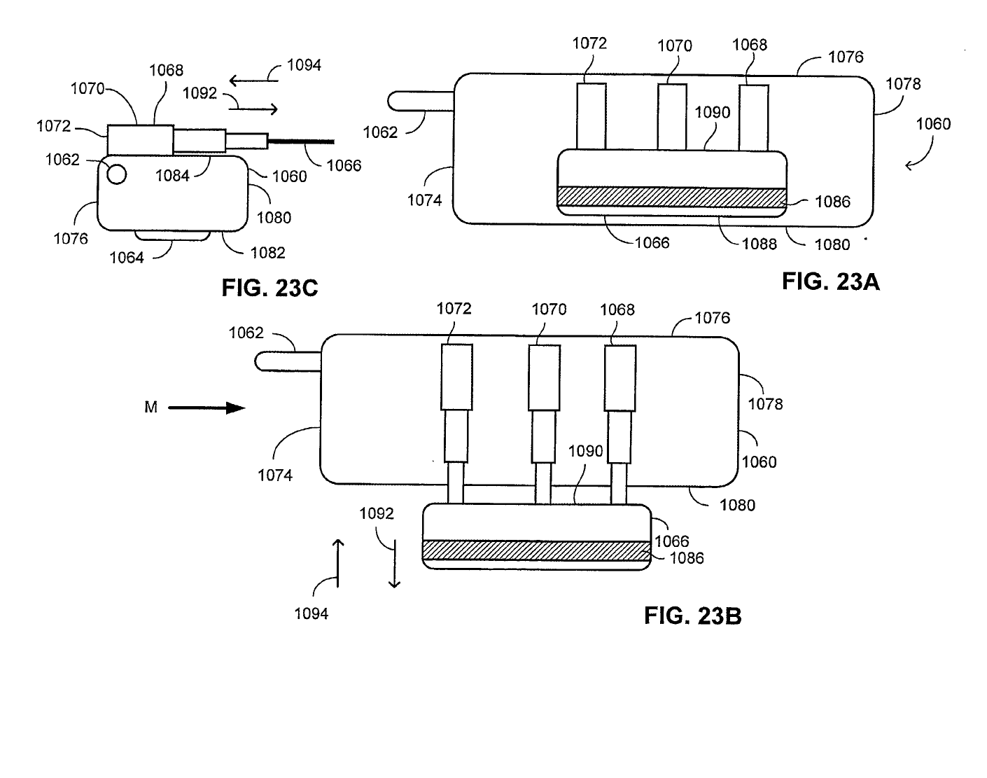

Reference is now made to FIGS. 23A, 23B and 23C. FIG. 23A is a schematic illustration of the rear view of a mobile terminal, generally referenced 1060, constructed and operative in accordance with another preferred embodiment of the present invention. FIG. 23B is a schematic illustration of the mobile terminal of FIG. 23A, with the credit card in an extended position. FIG. 23C is a schematic illustration of view M (top view) of the mobile terminal of FIG. 23B.

Mobile terminal 1060 includes an antenna 1062, a speaker 1064, a credit card 1066, a plurality of telescopic rods 1068, 1070 and 1072, a top side 1074, a left side 1076, a bottom side 1078, a right side 1080, a front side 1082 and a rear face 1084. Credit card 1066 includes a magnetic stripe 1086 at an outer edge 1088 thereof.

Telescopic rods 1068, 1070 and 1072 are connected to rear face 1084. The longitudinal axes of telescopic rods 1068, 1070 and 1072 are substantially perpendicular to the longitudinal axis of mobile terminal 1060. An inner edge 1090 of credit card 1066 is connected to telescopic rods 1068, 1070 and 1072. The dimensions of telescopic rods 1068, 1070 and 1072 are substantially identical to one another. Telescopic rods 1068, 1070 and 1072 are connected to rear face 1084, such that inner edge 1090 is substantially parallel with the longitudinal axis of mobile terminal 1060. Telescopic rods 1068, 1070 and 1072 can be extended together in a direction designated by an arrow 1092 and can be retracted together in a direction designated by an arrow 1094.

The user pulls credit card 1066 in direction 1092, whereby telescopic rods 1068, 1070 and 1072 extend (FIGS. 23B and 23C). In this extended position, the user can pass magnetic stripe 1086 through a card reader slot (not shown) of a card reader (not shown). The user can return credit card 1066 to the retracted position (FIG. 23A), by pushing credit card 1066 in direction 1094. Alternatively, telescopic rods 1068, 1070 and 1072 are connected to rear face 1084, such that telescopic rods 1068, 1070 and 1072 extend in direction 1094 and retract in direction 1092.

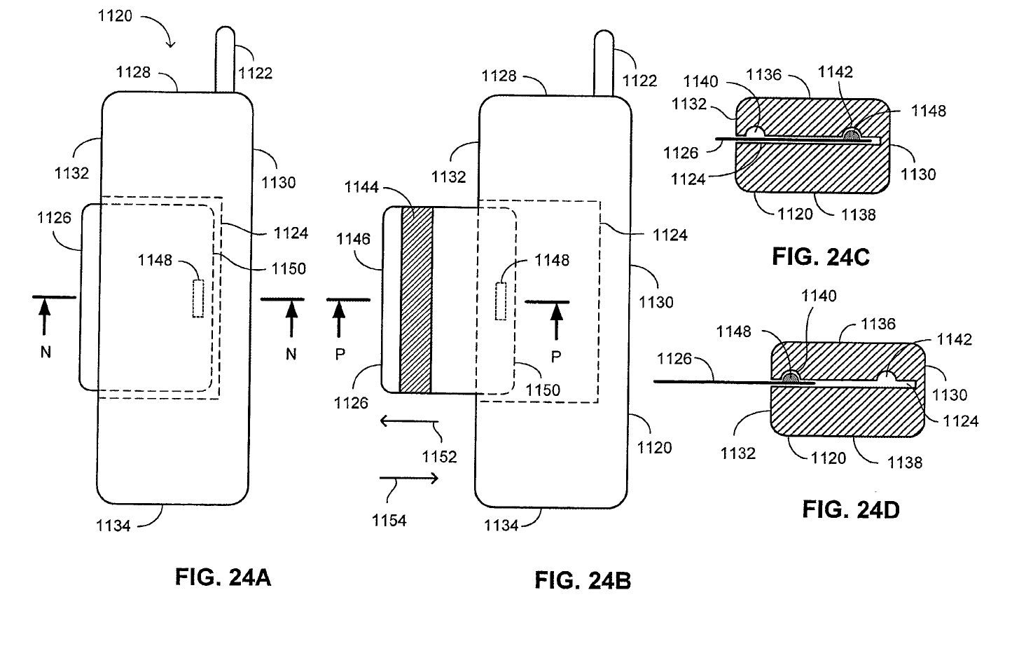

Reference is now made to FIGS. 24A, 24B, 24C and 24D. FIG. 24A is a schematic illustration of the rear view of a mobile terminal, generally referenced 1120, constructed and operative in accordance with a further preferred embodiment of the present invention. FIG. 24B is a schematic illustration of the mobile terminal of FIG. 24A, with the credit card in an extended position. FIG. 24C is a schematic illustration of section N-N of the mobile terminal of FIG. 24A. FIG. 24D is a schematic illustration of section P-P of the mobile terminal of FIG. 24B.

Mobile terminal 1120 includes an antenna 1122, a card slot 1124, a credit card 1126, a top side 1128, a left side 1130, a right side 1132, a bottom side 1134, a rear face 1136 and a front side 1138. Card slot 1124 includes a right recess 1140 and a left recess 1142. Credit card 1126 includes a magnetic stripe 1144 at an outer edge 1146 thereof. Credit card 1126 includes a credit card protrusion 1148 at an inner edge 1150 thereof.

Card slot 1124 is located in right side 1132. Right recess 1140 is located substantially close to right side 1132. Left recess 1142 is located substantially close to left side 1130.

With reference to FIGS. 24A and 24C, credit card protrusion 1148 is located inside left recess 1142, whereby most portion of credit card 1126 is inside card slot 1124 and credit card 1126 is locked in place in a retracted position. In this retracted position, outer edge 1146 protrudes from right side 1132. The user pulls outer edge 1146 in direction 1152. This pull on credit card 1126 forces credit card protrusion 1148 out of left recess 1142, whereby credit card 1126 can slide freely in card slot 1124, in direction 1152. The user pulls credit card 1126, further in direction 1152, whereby credit card protrusion 1148 enters right recess 1140 and whereby credit card 1126 locks in an extended position, partially out of card slot 1124 (FIGS. 24B and 24D). In this extended position, the user can pass magnetic stripe 1144 through a card reader slot (not shown) of a card reader (not shown).

The user can return credit card 1126 to the retracted position (FIGS. 24A and 24C), by pushing credit card 1126 in direction 1154. This push on credit card 1126, forces credit card protrusion 1148 out of right recess 1140, whereby credit card 1126 can freely slide in card slot 1124, in direction 1154. The user pushes credit card 1126, further in direction 1154, whereby credit card protrusion 1148 enters left recess 1142 and whereby credit card 1126 locks inside card slot 1124.

It is noted that the size and shape of credit card protrusion 1148 in FIGS. 24C and 24D, is exaggerated. In practice, credit card protrusion 1148 protrudes approximately 1 mm, form the surface of credit card 1126. The depth of right recess 1140 and left recess 1142 is also about 1 mm. Hence, credit card protrusion 1148 can move in and out of either right recess 1140 and left recess 1142, by applying a substantially small push and pull force on credit card 1126. Alternatively, card slot 1124 is located in left side 1130. Alternatively, either or both right side 1132 and left side 1130 include a plurality of card slots.

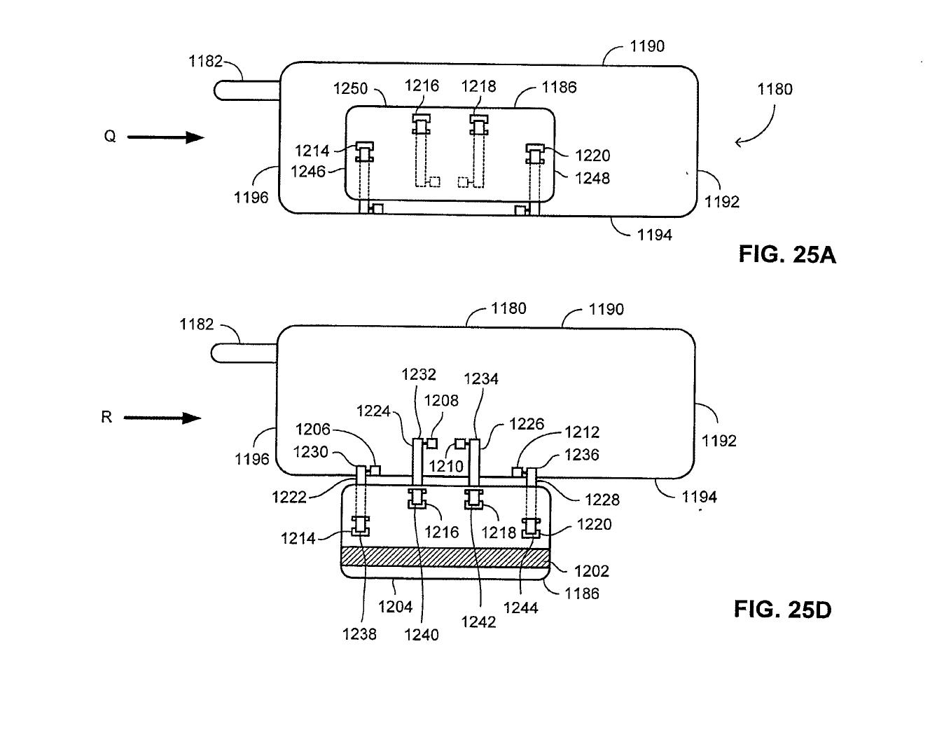

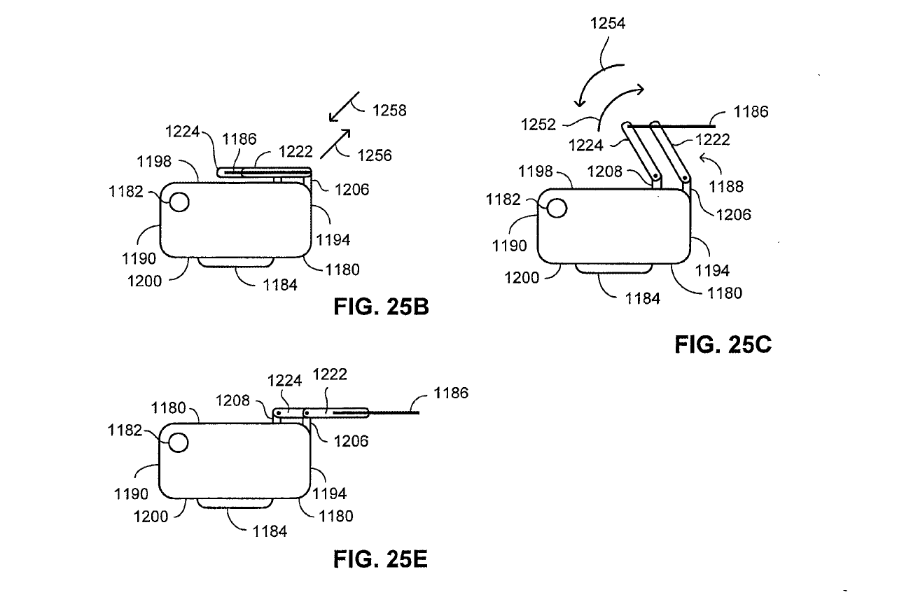

Reference is now made to FIGS. 25A, 25B, 25C, 25D and 25E. FIG. 25A is a schematic illustration of the rear view of a mobile terminal, generally referenced 1180, constructed and operative in accordance with another preferred embodiment of the present invention. FIG. 25B is a schematic illustration of view Q (top view) of the mobile terminal of FIG. 25A. FIG. 25C is a schematic illustration of the mobile terminal of FIG. 25B, with the four-bar linkage in an intermediate position. FIG. 25D is a schematic illustration of the mobile terminal of FIG. 25A, with the credit card in an extended position. FIG. 25E is a schematic illustration of view R (top view) of the mobile terminal of FIG. 25D.

Mobile terminal 1180 includes an antenna 1182, a speaker 1184, a credit card 1186, a four-bar linkage 1188 (FIG. 25C), a left side 1190, a bottom side 1192, a right side 1194, a top side 1196, a rear face 1198 and a front side 1200. Credit card 1186 includes a magnetic stripe 1202 (FIG. 25D), at an outer edge 1204 thereof.

Four-bar linkage 1188 includes hinges 1206, 1208, 1210, 1212, 1214, 1216, 1218 and 1220, and links 1222,1224,1226 and 1228. Hinges 1206 and 1212 are located substantially at the intersection of right side 1194 and rear face 1198. Hinges 1208 and 1210 are located on rear face 1198, between hinges 1206 and 1212, and away from right side 1194. Hinge 1214 is located in credit card 1186, substantially close to a top edge 1246 thereof. Hinge 1220 is located in credit card 1186, substantially close to a bottom edge 1248 thereof. Hinges 1216 and 1218 are located in credit card 1186, between hinges 1214 and 1220, and substantially close to an inner edge 1250 thereof.

Ends 1230, 1232, 1234 and 1236 of links 1222, 1224, 1226 and 1228, respectively, are connected to hinges 1206, 1208, 1210 and 1212, respectively. Ends 1238, 1240, 1242 and 1244 of links 1222, 1224, 1226 and 1228, respectively, are connected to hinges 1214, 1216, 1218 and 1220, respectively. Links 1222, 1224, 1226 and 1228 can rotate freely about hinges 1206, 1208, 1210 and 1212, in directions designated by arrows 1252 and 1254 (FIG. 25C).

The user pulls outer edge 1204 of credit card 1186, in a direction designated by an arrow 1256 (FIG. 25B), whereby four-bar linkage 1188 rotates in direction 1252 and credit card 1186 translates to an extended position (FIGS. 25D and 25E). During this translation, credit card 1186 remains in an orientation substantially parallel with rear face 1198. In this extended position, the user can pass magnetic stripe 1202 through a card reader slot (not shown) of a card reader (not shown).

The user can return credit card 1186 to the retracted position (FIGS. 25A and 25B), by pushing credit card 1186 in a direction designated by an arrow 1258, whereby four-bar linkage 1188 rotates in direction 1254. Alternatively, hinges 1206, 1208, 1210, 1212, 1214, 1216, 1218 and 1220, and links 1222, 1224, 1226 and 1228 are arranged such that credit card 1186 extends through rotation of the four-bar linkage in direction 1254 and credit card 1186 retracts through rotation of the four-bar linkage in direction 1252.

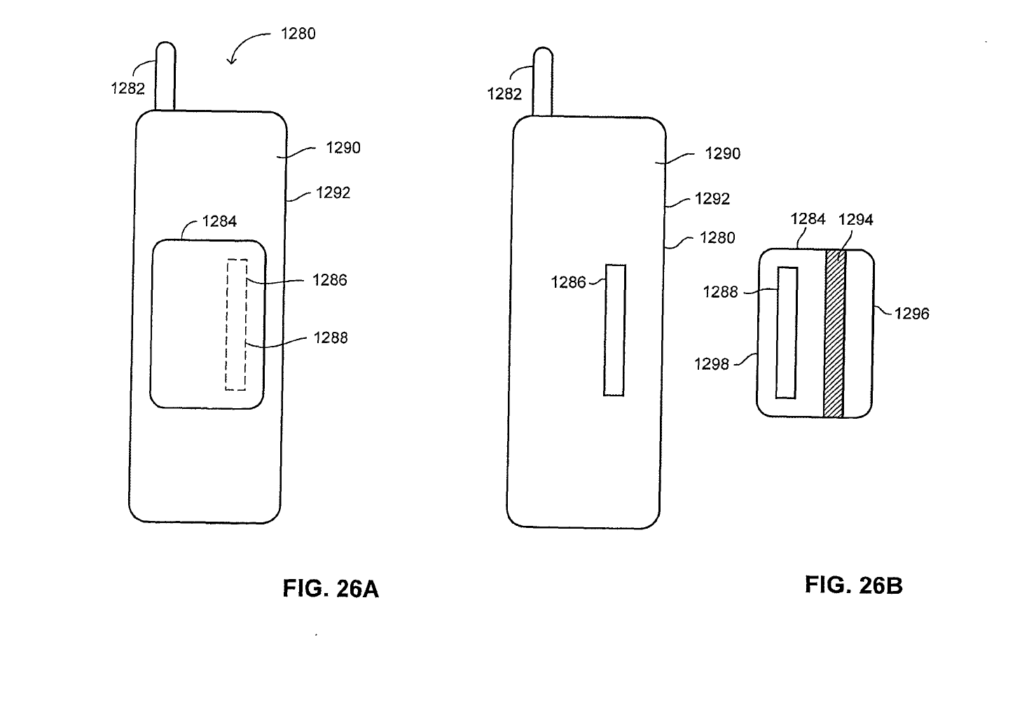

Reference is now made to FIGS. 26A and 26B. FIG. 26A is a schematic illustration of the rear view of a mobile terminal, generally referenced 1280, constructed and operative in accordance with a further preferred embodiment of the present invention. FIG. 26B is a schematic illustration of the mobile terminal of FIG. 26A, with the credit card detached from the mobile terminal.

Mobile terminal 1280 includes an antenna 1282, a credit card 1284, a mobile terminal magnet 1286, a credit card magnet 1288, a rear face 1290 and a left side 1292. Credit card 1284 includes a magnetic stripe 1294 at an outer edge 1296 thereof. Mobile terminal magnet 1286 and credit card magnet 1288 have substantially identical rectangular shapes. Mobile terminal magnet 1286 and credit card magnet 1288 are of opposite polarities, such that they are attracted to one another by a magnetic force.

Mobile terminal magnet 1286 is connected to rear face 1290 and is located substantially close to left side 1292. The longitudinal axis of mobile terminal magnet 1286 is substantially parallel with left side 1292. Credit card magnet 1288 is connected to the side of credit card 1284 which includes magnetic stripe 1294. Credit card magnet 1288 is located substantially close to an inner edge 1298 of credit card 1284. The longitudinal axis of credit card magnet 1288 is substantially parallel with inner edge 1298.

The user detaches credit card 1284 from rear face 1290, by pulling credit card 1284 (FIG. 26B). Thus, the user can pass magnetic stripe 1294 through a card reader slot (not shown) of a card reader (not shown). The user can replace credit card 1284 to rear face 1290, wherein credit card 1284 remains attached to rear face 1290, by the magnetic attraction force between mobile terminal magnet 1286 and credit card magnet 1288. It is noted that the mobile terminal magnet and the credit card magnet can be in other geometrical forms, such as circular, square, and the like. Alternatively, a plurality of mobile terminal magnets are connected to rear face 1290 and the same number of credit card magnets of opposite polarity are connected to the credit card.

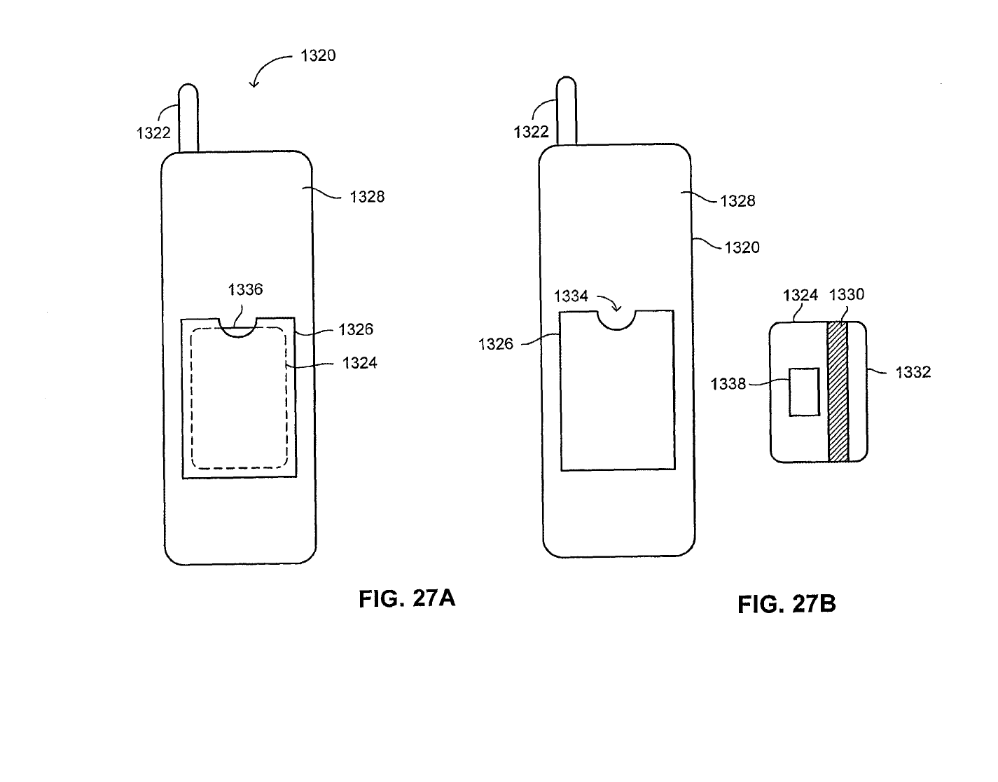

Reference is now made to FIGS. 27A and 27B. FIG. 27A is a schematic illustration of the rear view of a mobile terminal, generally referenced 1320, constructed and operative in accordance with another preferred embodiment of the present invention. FIG. 27B is a schematic illustration of the mobile terminal of FIG. 27A, with the credit card removed from the pocket.

Mobile terminal 1320 includes an antenna 1322, a credit card 1324, a pocket 1326 and a rear face 1328. Credit card 1324 includes a magnetic stripe 1330 substantially close to an outer edge 1332 thereof and an integrated circuit (IC) chip 1338 at the center thereof. IC chip 1338 is similar to the non-volatile medium, as described herein above in connection with step 200 of FIG. 4. Thus, the user can use credit card 1324 also as a “Smart Card”. Pocket 1326 includes a semi-circular cutout 1334 at the top thereof.

Pocket 1326 is made of a flexible plastic sheet, such as nylon, and the like, a rigid plastic, such as the material of rear face 1328, a textile, and the like. Pocket 1326 is connected to rear face 1328. Alternatively, pocket 1326 is integrated with rear face 1328. Credit card 1324 is located in pocket 1326.

The user removes credit card 1324 from pocket 1326 by gripping an edge 1336 of credit card 1324 through semi-circular cutout 1334. The user can pass magnetic stripe 1330 through a card reader slot (not shown) of a card reader (not shown). Then, the user replaces credit card 1324 in pocket 1326. Alternatively, a plurality of credit cards can be placed inside the pocket.

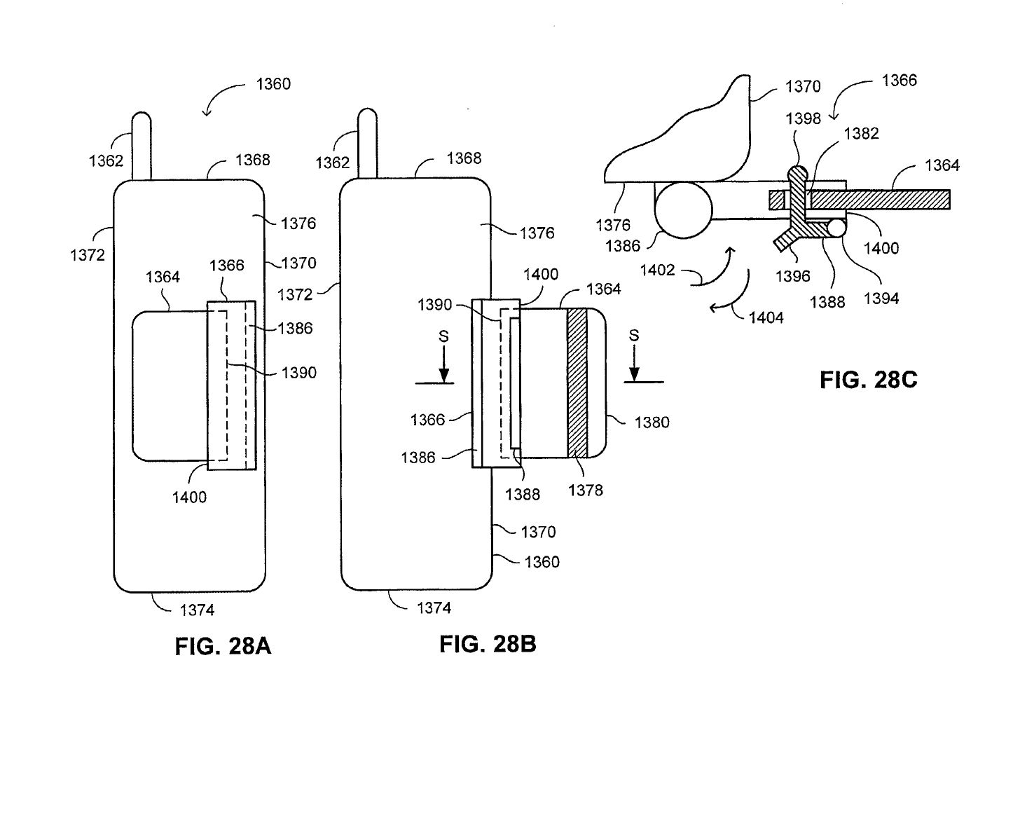

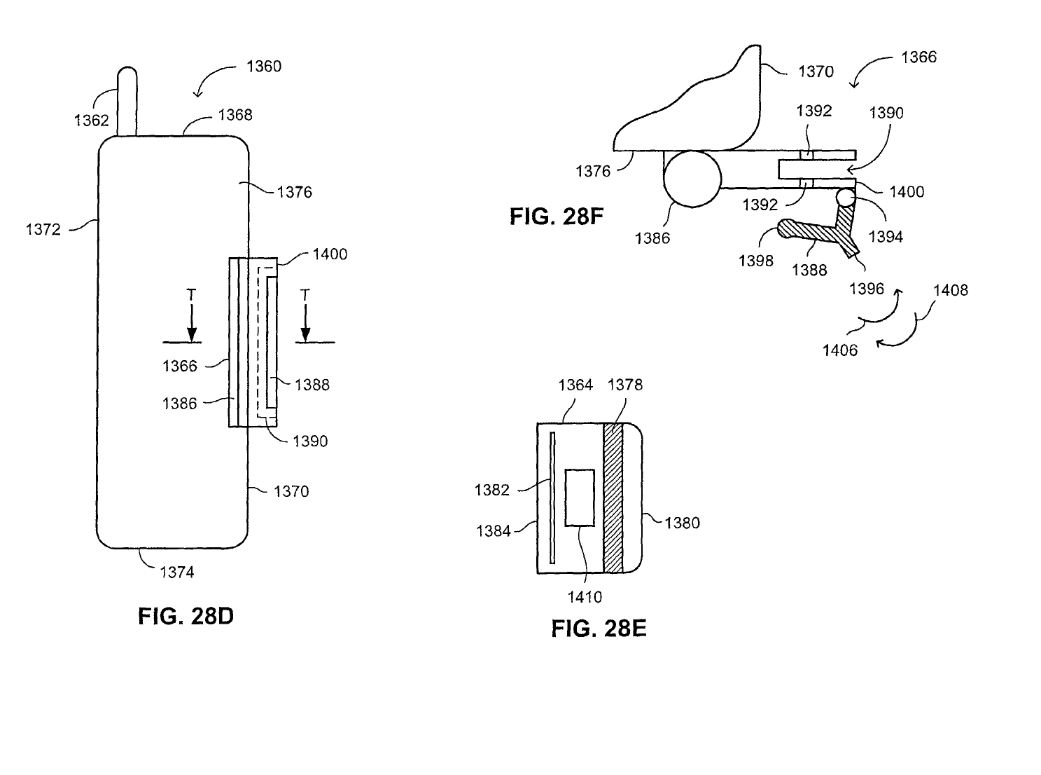

Reference is now made to FIGS. 28A, 28B, 28C, 28D, 28E and 28F. FIG. 28A is a schematic illustration of the rear view of a mobile terminal, generally referenced 1360, constructed and operative in accordance with a further preferred embodiment of the present invention. FIG. 28B is a schematic illustration of the mobile terminal of FIG. 28A, with the credit card in an extended position. FIG. 28C is a schematic illustration of section S-S of the credit card hinge assembly of FIG. 28B. FIG. 28D is a schematic illustration of the mobile terminal of FIG. 28B, without the credit card. FIG. 28E is a schematic illustration of the credit card of FIG. 28B. FIG. 28F is a schematic illustration of section T-T of the credit card hinge assembly of FIG. 28D.

Mobile terminal 1360 includes an antenna 1362, a credit card 1364, a credit card hinge assembly 1366, a top side 1368, a left side 1370, a right side 1372, a bottom side 1374 and a rear face 1376. Credit card 1364 includes a magnetic stripe 1378 at an outer edge 1380 thereof and an integrated circuit (IC) chip 1410 at the center thereof. Credit card 1364 further includes a credit card holding slot 1382 (FIG. 28E), at an inner edge 1384 thereof.

Credit card hinge assembly 1366 includes a primary hinge 1386, a credit card holder 1388, a longitudinal slot 1390 and a transverse slot 1392. Credit card holder 1388 includes a secondary hinge 1394, a stub 1396 and an enlarged edge 1398.

Credit card hinge assembly 1366 is located on rear face 1376, substantially close to left side 1370. Longitudinal slot 1390 is located at an outer edge 1400 of credit card hinge assembly 1366. Credit card 1364 is located in longitudinal slot 1390. Credit card holder 1388 is connected to outer edge 1400, by secondary hinge 1394. Credit card hinge assembly 1366 can rotate about primary hinge 1386 in directions designated by arrows 1402 and 1404. Credit card holder 1388 can rotate about secondary hinge 1394 in directions designated by arrows 1406 and 1408. IC chip 1410 is similar to the non-volatile medium, as described herein above in connection with step 200 of FIG. 4. Thus, the user can use credit card 1364 also as a “Smart Card”.

The user can use credit card 1364 while attached to mobile terminal 1360 (FIGS. 28B and 28C), or while detached therefrom (FIGS. 28D, 28E and 28F). To use credit card 1364 in the attached mode, the user rotates credit card hinge assembly 1366 in direction 1402, whereby credit card 1364 is extended (FIGS. 28B and 28C). In this extended position, the user can pass magnetic stripe 1378 through a card reader slot (not shown) of a card reader (not shown). The user can return credit card 1364 to the retracted position, by rotating credit card hinge assembly 1366 in direction 1404.

To use credit card 1364 in the detached mode, the user rotates credit card hinge assembly 1366 in direction 1402 and further rotates credit card holder 1388 in direction 1406 by gripping stub 1396. Thus, enlarged edge 1398 exits transverse slot 1392 and credit card holding slot 1382 (FIGS. 28E and 28F), thereby setting credit card 1364 free. The user can pull out credit card 1364 from longitudinal slot 1390 (FIG. 28E) and pass magnetic stripe 1378 through a card reader slot (not shown) of a card reader (not shown).

The user can return credit card 1364 to the retracted mode, in two steps. The user first inserts credit card 1364 to longitudinal slot 1390, and rotates credit card holder 1388 in direction 1408 by gripping stub 1396. Thus, enlarged edge 1398 enters credit card holding slot 1382 and transverse slot 1392, thereby locking credit card 1364 to credit card hinge assembly 1366 (FIGS. 28B and 28C). The user, then rotates credit card hinge assembly 1366 in direction 1404, thereby returning credit card 1364 to the retracted position (FIG. 28A).

It is noted that primary hinge 1386 and secondary hinge 1394 are of the types known in the art, such as including a combination of a rod and a hollow shaft, being in the form of a narrow flexible plastic section, and the like. It is further noted that credit card holder 1388 can be devoid of any secondary hinge and be connected to credit card hinge assembly 1366 by a string, a chain, and the like.

It will be appreciated by persons skilled in the art that the present invention is not limited to what has been particularly shown and described hereinabove. Rather the scope of the present invention is defined only by the claims, which follow.

1. Payment device comprising:
a mobile terminal; and
at least one financial data storage element,
wherein said mobile terminal and said at least one financial data storage element are logically associated, and
wherein said at least one financial data storage element is coupled to said mobile terminal.

2. The payment device according to claim 1, wherein said at least one financial data storage element is associated with said mobile terminal, through a look-up table located in a remote authorizing node.

3. The payment device according to claim 1, wherein said at least one financial data storage element is a card and wherein credit card information is stored on a magnetic stripe embedded in said card.

4. The payment device according to claim 1, wherein said at least one financial data storage element is a smart card, said smart card including an integrated circuit chip and wherein credit card information is stored on said integrated circuit chip.

5. The mobile terminal according to claim 3, wherein at least portions of said credit card information are selected from the list consisting of:
credit card number;
credit card type;
user secret code; and
user information.

6. The payment device according to claim 1, wherein said at least one financial data storage element is a card and wherein credit card information is stored in a credit card storage medium coupled to said card.

7. The payment device according to claim 6, wherein said credit card storage medium is selected from the list consisting of:
electrically erasable programmable read only memory;
static random access memory;
dynamic random access memory; and
synchronous dynamic random access memory

8. The payment device according to claim 1, wherein said at least one financial data storage element can be detached from said mobile terminal.

9. The mobile terminal according to claim 1, wherein said mobile terminal is associated with a mobile ID.

10. The mobile terminal according to claim 9, wherein said mobile ID is selected from the list consisting of:
mobile identification number;
universal personal telecommunications number;
terminal identifier; and
personal identification number.

11. The payment device according to claim 1, wherein said mobile terminal further comprises at least one card release button and at least one card slot,
wherein said at least one card release button is coupled to said at least one financial data storage element through at least one release mechanism,
wherein said at least one financial data storage element draws out of said at least one card slot, when said at least one card release button is depressed, and
wherein said at least one financial data storage element remains in a drawn in position within said at least one card slot, when said at least one financial data storage element is depressed.

12. The payment device according to claim 11, wherein said at least one card release button is located on a side of said mobile terminal, wherein said side is selected from the list consisting of:
right;
left;
top;
bottom;
front; and
rear.

13. The payment device according to claim 11, wherein said at least one card slot is located on a side of said mobile terminal, wherein said side is selected from the list consisting of:
right;
left;
top;
bottom;
front; and
rear.

14. The payment device according to claim 11, wherein said at least one financial data storage element is substantially rectangular.

15. The payment device according to claim 11, wherein said at least one financial data storage element is a segment of a circle, said at least one financial data storage element rotates about a hinge.

16. The payment device according to claim 1, wherein said at least one financial data storage element is coupled to said mobile terminal through a hinge and said at least one financial data storage element rotates about said hinge.

17. The payment device according to claim 16, wherein said hinge is located at an intersection of sides of said mobile terminal, selected from the list consisting of:
front and top;
front and bottom;
front and right;
front and left;
rear and top;
rear and bottom;
rear and right;
rear and left;
right and top;
right and bottom;
left and top; and
left and bottom.

18. The payment device according to claim 16, wherein said mobile terminal further comprises a stop located in the vicinity of said hinge, and a spring element is coupled between said at least one financial data storage element and said mobile terminal,
wherein said at least one financial data storage element toggles to an extended position by a spring force of said spring element, and said at least one financial data storage element remains in said extended position against said stop, and
wherein said at least one financial data storage element toggles to a retracted position by another spring force of said spring element and said at least one financial data storage element remains in said retracted position against a side of said mobile terminal.

19. The payment device according to claim 16, wherein said at least one financial data storage element is coupled to said hinge by a credit card holder, said credit card holder comprises a card holder slot, each of said at least one financial data storage element and said card holder slot includes a stop,
wherein said credit card holder rotates about said hinge and said at least one financial data storage element partially slides out of said card holder slot and remains in an extended position against said stop, and
wherein said at least one financial data storage element slides into said card holder slot and said credit card holder rotates about said hinge to a retracted position.

20. The payment device according to claim 16, wherein said at least one financial data storage element is coupled to said hinge by a right arm and a left arm.

21. The payment device according to claim 16, wherein the shape of said at least one financial data storage element is substantially a parallelogram.

22. The payment device according to claim 16, wherein said at least one financial data storage element further comprises a right protrusion and a left protrusion, and said mobile terminal further comprises a right latch and a left latch,
wherein said at least one financial data storage element is in a retracted position when said left protrusion is in a recess of said left latch, and said at least one financial data storage element is in an extended position when said right protrusion is in another recess of said right latch.

23. The payment device according to claim 16, wherein said mobile terminal is a flip-phone, said at least one financial data storage element is located between a flipping cover and a headset of said mobile terminal, and said flipping cover rotates about said hinge.

24. The payment device according to claim 1, wherein said at least one financial data storage element is coupled to said mobile terminal through a telescopic rod, said telescopic rod comprising an outer telescopic rod coupled to said mobile terminal, and a plurality of inner telescopic rods rotating inside said outer telescopic rod and axially moving relative to said outer telescopic rod, said at least one financial data storage element is coupled to an outer one of said inner telescopic rods.

25. The payment device according to claim 1, wherein an inner edge of said at least one financial data storage element is coupled to said mobile terminal through a plurality of telescopic rods, the longitudinal axis of said telescopic rods is substantially perpendicular to the longitudinal axis of said mobile terminal.

26. The payment device according to claim 1, wherein said mobile terminal further comprises at least one card slot, said at least one card slot further comprises a right recess and a left recess, said at least one financial data storage element further comprises a credit card protrusion,
wherein said at least one financial data storage element is in an extended position when said credit card protrusion is inside said right recess, and said at least one financial data storage element is in a retracted position when said credit card protrusion is inside said left recess.

27. The payment device according to claim 1, wherein said at least one financial data storage element is coupled to said mobile terminal by a four-bar linkage.

28. The payment device according to claim 1, wherein said at least one financial data storage element is coupled to said mobile terminal by at least one mobile terminal magnet and at least one credit card magnet, and
wherein said at least one mobile terminal magnet is coupled to said mobile terminal and said at least one credit card magnet is coupled to said at least one financial data storage element.

29. The payment device according to claim 1, wherein said at least one financial data storage element is stored in at least one pocket coupled to said mobile terminal.

30. The payment device according to claim 29, wherein said at least one pocket is made of a material selected from the list consisting of:
flexible plastic;
rigid plastic; and
textile.

31. The payment device according to claim 1, wherein said at least one financial data storage element is coupled to said mobile terminal, by a credit card hinge assembly, said credit card hinge assembly coupled to said mobile terminal by a primary hinge, said credit card hinge assembly further comprising a credit card holder, said credit card holder further comprising a secondary hinge,
wherein said at least one financial data storage element is in a first extended position, when said credit card hinge assembly is rotated about said primary hinge, and
wherein said at least one financial data storage element is in a second extended position, when said credit card hinge assembly is rotated about said primary hinge, said credit card holder is rotated about said secondary hinge, whereby said at least one financial data storage element is detached from said credit card hinge assembly.

32. Card holder for coupling at least one financial data storage element to a mobile terminal,
wherein said card holder is coupled to said mobile terminal; and
wherein said at least one financial data storage element is logically associated with said mobile terminal.

33. The card holder according to claim 32, wherein said card holder comprises at least one mobile terminal magnet coupled to said mobile terminal, and at least one credit card magnet coupled to said at least one financial data storage element.

34. The card holder according to claim 32, wherein said card holder comprises at least one pocket coupled to said mobile terminal.

35. The card holder according to claim 34, wherein said at least one pocket is made of a material selected from the list consisting of:
flexible plastic;
rigid plastic; and
textile.

36. The card holder according to claim 32, wherein said card holder is a credit card hinge assembly, said credit card hinge assembly coupled to said mobile terminal by a primary hinge, said credit card hinge assembly further comprising a credit card holder.

37. Flipping cover detachably attached to a flip-phone type mobile terminal, said flipping cover comprising credit card information,
wherein said credit card information is logically associated with said flip-phone type mobile terminal.

38. The flipping cover according to claim 37, wherein said credit card information is stored on a magnetic stripe embedded in said flipping cover.

39. The flipping cover according to claim 37, wherein said credit card information is selected from the list consisting of:
credit card number;
user secret code; and
user information.

40. The flipping cover according to claim 37, wherein said credit card information is stored in a credit card storage medium coupled to said flipping cover.

41. The flipping cover according to claim 40, wherein said credit card storage medium is selected from the list consisting of:
electrically erasable programmable read only memory;
static random access memory;
dynamic random access memory; and
synchronous dynamic random access memory

42. Method for authenticating a user who performs a transaction, by employing a financial data storage element coupled to a mobile terminal, the method comprising the steps of:
initiating communication with said mobile terminal, according to a mobile ID of said mobile terminal;
requesting a user secret code;
receiving said user secret code from said mobile terminal at a remote authorizing node; and
determining the authenticity of said user.

43. The method according to claim 42, further comprising a preliminary step of determining said mobile ID.

44. The method according to claim 43, wherein said mobile ID is determined by referring to a look-up table located in said remote authorizing node.

45. The method according to claim 43, wherein said mobile ID is determined according to user information embedded in transaction data.

46. The method according to claim 44, wherein said look-up table includes a list of unauthorized credit card numbers, and a plurality of fields in a record associated with each of a plurality of credit card numbers.

47. The method according to claim 46, wherein the type of said fields is selected from the list consisting of:
said user secret code;
said mobile ID;
unique audio data;
unique alphanumeric data;
unique visual data; and
account status.

48. The method according to claim 47, wherein said account status field comprises information selected from the list consisting of:
non-authenticated-limit-value;
authenticated-limit-value; and
transaction code.

49. The method according to claim 43, further comprising a preliminary step of transmitting credit card information to said remote authorizing node.

50. The method according to claim 49, wherein said step of transmitting is performed via a network.

51. The method according to claim 49, further comprising a preliminary step of retrieving credit card information which is stored in a credit card storage medium.

52. The method according to claim 51, wherein said step of retrieving is performed by passing said credit card storage medium through a card reader slot of a card reader.

53. The method according to claim 51, wherein said step of retrieving is performed by interfacing said credit card storage medium with a data transfer interface.

54. The method according to claim 42, further comprising a step of authorizing said transaction by generating a transaction authorization code for said transaction, when said user is authentic, and denying said transaction when said user is not authentic.

55. The method according to claim 54, further comprising a step of transmitting said transaction authorization code to said mobile terminal, for further reporting to a service unit.

56. The method according to claim 54, further comprising a step of transmitting said transaction authorization code to a service unit.

57. The method according to claim 55, wherein said step of transmitting is performed via a network.

58. The method according to claim 57, wherein said step of transmitting is performed via a network.

59. The method according to claim 42, further comprising a step of comparing a received credit card number with a list of unauthorized credit card numbers, before said step of determining.

60. The method according to claim 59, wherein said remote authorizing node authorizes said transaction when said received credit card number does not match a number in said list of unauthorized credit card numbers, and
wherein said remote authorizing node denies said transaction when said received credit card number matches said number in said list of unauthorized credit card numbers.

61. The method according to claim 59, further comprising a step of comparing a transaction value with a non-authenticated-limit-value, wherein said non-authenticated-limit-value is stored in a look-up table.

62. The method according to claim 61, wherein said remote authorizing node authorizes said transaction when said transaction value is less than said non-authenticated-limit-value, and
wherein said remote authorizing node denies said transaction when said transaction value is greater than said non-authenticated-limit-value.

63. The method according to claim 59, further comprising a step of comparing a transaction value with a non-authenticated-limit-value and an authenticated-limit-value, wherein said non-authenticated-limit-value and said authenticated-limit-value are stored in a look-up table.

64. The method according to claim 63, wherein said remote authorizing node performs said step of determining when said transaction value is between said non-authenticated-limit-value and said authenticated-limit-value, and denies said transaction when said transaction value is greater than said authenticated-limit-value.

65. The method according to claim 42, wherein said step of determining further comprises a step of comparing a received secret code with a retrieved secret code.

66. The method according to claim 65, wherein said remote authorizing node authenticates said user when said received secret code matches said retrieved secret code, and
wherein said remote authorizing node does not authenticate said user when said received secret code does not match said retrieved secret code.

67. The method according to claim 42, wherein said remote authorizing node determines whether said user responds to said communication initiation.

68. The method according to claim 67, wherein said remote authorizing node authorizes said transaction when said user responds to said communication initiation, and
wherein said remote authorizing node denies said transaction when said user does not respond to said communication initiation.

69. The method according to claim 42, wherein said step of determining further comprises a step of comparing received voice characteristics with retrieved voice characteristics.

70. The method according to claim 69, wherein said remote authorizing node authorizes said transaction when said received voice characteristics match said retrieved voice characteristics, and
wherein said remote authorizing node denies said transaction when said received voice characteristics do not match said retrieved voice characteristics.

71. The method according to claim 42, wherein said step of determining further comprises a step of comparing at least one received alphanumeric character with at least one retrieved alphanumeric character.

72. The method according to claim 71, wherein said remote authorizing node authorizes said transaction when said at least one received alphanumeric character matches said at least one retrieved alphanumeric character, and
wherein said remote authorizing node denies said transaction when said at least one received alphanumeric character does not match said at least one retrieved alphanumeric character.

73. The method according to claim 42, wherein said step of determining further comprises a step of comparing a processed image with a retrieved image.

74. The method according to claim 73, wherein said remote authorizing node authorizes said transaction when said processed image matches said retrieved image, and
wherein said remote authorizing node denies said transaction when said processed image does not match said retrieved image.

75. The method according to claim 42, further comprising a step of determining a transaction code for said transaction, after said step of retrieving.

76. The method according to claim 75, further comprising a step of receiving said transaction code from a service unit, by said remote authorizing node.

77. The method according to claim 76, further comprising a step of comparing said received transaction code with a stored transaction code.

78. The method according to claim 77, wherein said remote authorizing node authorizes said transaction when said received transaction code matches said stored transaction code, and
wherein said remote authorizing node denies said transaction when said received transaction code does not match said stored transaction code.

79. The method according to claim 42, further comprising a step of producing a retrieved authentication secret code, by applying an authorizing time function to a retrieved user secret code, before said step of requesting.

80. The method according to claim 79, further comprising a step of producing an authentication secret code, by applying a mobile terminal time function to an entered user secret code, after said step of requesting.

81. The method according to claim 80, further comprising a step of receiving said authentication secret code from said mobile terminal, by said remote authorizing node.

82. The method according to claim 81, further comprising a step of comparing said retrieved authentication secret code with said received authentication secret code.

83. The method according to claim 82, wherein said remote authorizing node authorizes said transaction when said received authentication secret code matches said retrieved authentication secret code, and
wherein said remote authorizing node denies said transaction when said received authentication secret code does not match said retrieved authentication secret code.

84. The method according to claim 80, wherein said authorizing time function is substantially identical with said mobile terminal time function.

85. Method for authenticating a user who performs a transaction, by employing a financial data storage element coupled to a mobile terminal, the method comprising the steps of:
determining a first authentication code according to credit card information stored in a credit card storage medium;
receiving a user secret code by said mobile terminal, from said user;
determining a second authentication code according to said user secret code; and
comparing said first authentication code with said second authentication code.

86. The method according to claim 85, further comprising a preliminary step of retrieving said credit card information.

87. The method according to claim 85, further comprising a step of transmitting said second authentication code to a service unit, before said step of comparing.

88. The method according to claim 85, further comprising a step of reporting said second authentication code to said user, after said step of determining said second authentication code.

89. The method according to claim 88, further comprising a step of receiving said second authentication code by a service unit, from said user, after said step of reporting.

90. The method according to claim 85, further comprising a step of completing said transaction after said step of comparing, when said first authentication code matches said second authentication code.

91. The method according to claim 85, further comprising a step of denying said transaction after said step of comparing, when said first authentication code does not match said second authentication code.

92. The method according to claim 85, wherein said step of receiving said user secret code is performed, when a transaction value is greater than a predetermined value.

93. The method according to claim 85, wherein said first authentication code is determined by applying a service unit time function to a retrieved user secret code.

94. The method according to claim 93, wherein said second authentication code is determined by applying a mobile terminal time function to an entered user secret code.

95. The method according to claim 94, wherein said service unit time function is substantially identical with said mobile terminal time function.

96. The method according to claim 93, wherein a service unit retrieves said retrieved user secret code from a look-up table.

97. The method according to claim 96, wherein said look-up table includes information selected from the list consisting of:
approved credit card number list; and
local list of unauthorized credit card numbers.

98. The method according to claim 97, wherein each of a plurality of credit card numbers in said approved credit card number list, points to a different user secret code.

99. The method according to claim 85, further comprising a step of transmitting a request to said mobile terminal to enter said user secret code by said user, before said step of receiving said user secret code.

100. The method according to claim 99, wherein said step of transmitting said request is performed wirelessly.

101. The method according to claim 87, wherein said step of transmitting said second authentication code is performed according to a short range radio communication protocol.

102. The method according to claim 85, further comprising a step of requesting said user to enter said user secret code to said mobile terminal, before said step of receiving.

103. The method according to claim 102, wherein said step of requesting is performed via a service unit user interface.

104. The method according to claim 102, wherein said step of requesting is performed via said mobile terminal, according to a short range radio communication protocol.

105. The method according to claim 89, wherein said step of receiving said second authentication code is performed via a service unit user interface of said service unit.

106. The method according to claim 89, wherein said step of receiving said second authentication code is performed according to a short range radio communication protocol.

107. The method according to claim 85, further comprising a step of comparing a received credit card number with a local list of unauthorized credit card numbers when a transaction value is greater than a predetermined value, after said step of retrieving.

108. The method according to claim 107, wherein a service unit authorizes said transaction when said received credit card number does not match a number in said local list of unauthorized credit card numbers, and
wherein said service unit denies said transaction when said received credit card number matches said number in said local list of unauthorized credit card numbers.

109. The method according to claim 86, wherein said step of retrieving is performed by interfacing said credit card storage medium with a data transfer interface.

110. The method according to claim 85, wherein said credit card information is selected from the list consisting of:
credit card number;
user secret code;
user information; and
authorized list of transaction codes.

111. The method according to claim 85, further comprising a step of comparing a requested transaction code with an authorized list of transaction codes, after said step of comparing said first authentication code with said second authentication code.

112. The method according to claim 111, wherein a service unit authorizes said transaction when said requested transaction code matches a transaction code in said authorized list of transaction codes, and
wherein said service unit denies said transaction when said requested transaction code does not match said transaction code in said authorized list of transaction codes.
